(19) United States
(12) Patent Application Publication
(10) Pub. No.: US 2021/0084882 A1
(43) Pub. Date: Mar. 25, 2021

(54) AUTONOMOUS MOSQUITO CONTROL

(71) Applicants: TIMOTHY AMYAS HARTNOLL, Binjai Park (SG); ERICH JOHANN DOLLANSKY, Jawa Tengah (ID); SUMARNI N.A, Jawa Tengah (ID)

(72) Inventors: TIMOTHY AMYAS HARTNOLL, Binjai Park (SG); ERICH JOHANN DOLLANSKY, Jawa Tengah (ID); SUMARNI N.A, Jawa Tengah (ID)

(21) Appl. No.: 16/965,923

(22) PCT Filed: Jan. 30, 2019
(86) PCT No.: PCT/SG2019/050051

§ 371 Date: Jul. 29, 2020

(30) Foreign Application Priority Data
Feb. 1, 2018 (SG) 10201800869Y

(51) Int. Cl. A01M 1/02; A01M 1/10; G05D 1/00

(52) U.S. Cl. CPC A01M 1/026; A01M 1/106; A01M 2200/012; G05D 1/005; G05D 1/0088

(57) ABSTRACT

A system for the automated management of a water-breeding insect population, the system comprising: at least one ovitrap comprising a container arranged to hold a liquid and collect the eggs of a water-breeding insect; one or more autonomous vehicles; and an ovitrap manager configured to communicate with the one or more autonomous vehicles to instruct an autonomous vehicle to perform one or more tasks to administer maintenance of one or more ovitrap s. The maintenance of the ovitraps is carried out by autonomous vehicles, thereby reducing or eliminating human involvement. Furthermore, the ovitraps themselves may be cheap and replaceable such that a large number may be deployed to cope with increasing insect populations. They also may be spread across a wide area since the autonomous vehicles travel to the ovitraps such that there is no burden placed on human operators in travelling to maintain the traps.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from International PCT Patent Application No. PCT/SG2019/050051, filed Jan. 30, 2019 entitled, “AUTONOMOUS MOSQUITO CONTROL”, which claims priority to Singapore Patent Application Nos. 10201800869Y, filed Feb. 1, 2018 of which are incorporated herein by reference in their entirety.

### BACKGROUND

The present invention relates to a system and method of controlling water-breeding insects such as mosquitoes.

Some 1.5 million people die every year as a result of a mosquito bite. The World Health Organization considers mosquito control as a critical element of any mosquito-borne disease prevention. The effectiveness of any method using chemical agents is dropping more and more. This is proven by the world-wide rise of mosquito-related fatalities.

One known method for managing the population of mosquitoes and other water-breeding insects in the use of ovitraps. An ovitrap is a device in which water-breeding insects can lay their eggs. An ovitrap generally includes a container containing water and optionally a substrate where insects can lay their eggs. An ovitrap is used to attract water breeding insects like mosquitoes to deposit their eggs into it. Depending on the insects, the eggs might be deposited on the walls of the ovitrap near the water surface or directly onto the water surface itself. Larvae will emerge after some time out of the eggs. The larvae will develop over time into pupae and finally into the adult insect. The presence of water is essential for the development of the insect. Emptying the ovitrap before the adult insect emerges disrupts the development cycle as the already developed larvae and/or pupae will be either removed together with the other content of the ovitrap or dry out and die. As such, the insect which deposited its eggs into the ovitrap dies without off-spring, thereby reducing the number of new adult insects which can spread diseases.

An ovitrap can be either a permanent ovitrap or a temporary ovitrap. A permanent ovitrap is installed permanently at a location. A temporary ovitrap can easily be moved between locations. The concept of automatic lethal ovitraps was introduced in PCT application PCT SG 2007 000137. Such traps may be permanently installed and have automated functionality such that they can carry out certain tasks automatically, for example, filling the container with liquid to a desired level and emptying the container when required to destroy collected insect eggs.

However a problem still remains in that the population density of insects across a region can fluctuate with higher numbers of insects found in a particular region at a particular time and higher numbers of insects found in other regions at other times. It is therefore difficult to constantly monitor the insect population changes and provide appropriate numbers of ovitraps at the correct locations and maintain these ovitraps. Permanent automated ovitraps suffer from the difficulties that they are expensive and cannot readily be moved and redeployed so lack the necessary flexibility to address the above issues. Whereas temporary ovitraps require constant management and therefore the amount of labour involved in constantly moving and replenishing the ovitraps is too high to make their use viable.

Accordingly there is a need for a system of managing insect populations which can adapt to the changing numbers of insects in a given area which makes progress in addressing the above problems.

### SUMMARY OF THE INVENTION

According to the present invention there is provided a system for the automated management of a water-breeding insect population, the system comprising: at least one ovitrap comprising a container arranged to hold a liquid and collect the eggs of a water-breeding insect; one or more autonomous vehicles; and an ovitrap manager configured to communicate with the one or more autonomous vehicles to instruct an autonomous vehicle to perform one or more tasks to administer maintenance of one or more ovitraps.

In this way, the maintenance of the ovitraps is carried out by autonomous vehicles, thereby reducing or eliminating human involvement. Furthermore, the ovitraps themselves may be cheap and replaceable such that a large number may be deployed to cope with increasing insect populations. They also may be spread across a wide area since the autonomous vehicles travel to the ovitraps such that there is no burden placed on human operators in travelling to maintain the traps. The locations of the ovitraps may also be changed by the autonomous vehicles to address the changing locations of water-breeding insects.

Preferably one or more ovitraps is a moveable or mobile ovitrap which can be repositioned by an autonomous vehicle. The plurality of ovitraps may comprise one or more permanent ovitraps arranged to be installed in a fixed location. The permanent ovitraps may be automated such that they carry out the essential maintenance functions of an ovitrap automatically. In particular, they may automatically fill the container to a desired level and release or purge the liquid when a sufficient number of eggs have been collected.

The autonomous vehicle is preferably an unmanned vehicle configured to navigate around a region independently. The autonomous vehicle may be configured to navigate across air and/or land and/or water. The autonomous vehicle may be configured to receive communications signals via a communications interface such that instructions may be sent to the autonomous vehicle to determine the tasks to be carried out by the vehicle. The autonomous vehicle may comprise a memory unit arranged to hold preprogrammed instructions to perform on or more tasks. The autonomous vehicle may additionally comprise an on-board computer configured to determine tasks to be carried out by the autonomous vehicle.

The autonomous vehicle may further comprise a fresh container store configured to hold one or more fresh containers for use with the ovitraps; wherein the autonomous vehicle is configured to replace the container of an ovitrap with a fresh container held in the fresh container store when instructed by the ovitrap manager; wherein the fresh containers held in the container store may be empty or filled with a liquid.

The autonomous vehicle may further comprise a liquid store arranged to hold liquid for filling a container for use with an ovitrap; and a container filling unit configured to fill a container with liquid from the liquid store; wherein the autonomous vehicle is configured to fill a container with a liquid from the liquid store to refill an ovitrap when instructed by the ovitrap manger.

With this additional functionality the automated vehicle can administer a number of additional tasks to the ovitrap, allowing the vehicle to refill and replace ovitraps without having to travel back to a station to refill the ovitraps or collect fresh ovitraps.

The ovitrap manager may be a remote unit with a communications interface configured to send instructions to one or more autonomous vehicles. The ovitrap manager may be referred to as an ovitrap section manager, a local manager or a global manager. Preferably the system comprises a plurality of ovitrap managers which are each configured to communicate with each other. Preferably the multiple ovitrap managers have a hierarchical arrangement. For example, each section manager may administer the maintenance of a number of ovitraps in a first region. The system may further comprise a plurality of local managers, each configured to administer instructions to and receive data from a plurality of section managers in a second region, larger than the first region. The system may further comprise a plurality of global managers, each configured to administer instructions to and receive data from a plurality of local managers in a third region, larger than the second region. Each manager at a level in the hierarchy may be connected to all managers in the same level, the level below and the level above. Preferably there are at least three managers at each level of the hierarchy such that, if one manager in a level malfunctions, the system is still operable as the remaining managers in the level can share data.

The ovitrap manager may be part of an ovitrap handler where an ovitrap handler is also referred to as an autonomous vehicle service station.

The one or more tasks preferably comprise an essential task required for the ovitrap to function. The one or more tasks may include a maintenance task required to maintain the ovitrap in working order. In particular, the autonomous vehicles may be instructed to position an ovitrap in a desired location, fill it to the correct level and collect it (or empty/dry it or otherwise destroy or remove the eggs) before the eggs develop into adult insects. The task may include monitoring the ovitraps and sending data to a human operator to administer the maintenance tasks.

Preferably the one or more tasks comprise one or more of: moving an ovitrap or the container of an ovitrap; refilling an ovitrap with a substance; emptying an ovitrap; drying an ovitrap; removing an ovitrap or the container of an ovitrap; replacing an ovitrap or the container of an ovitrap; recording data relating to an ovitrap; searching for an ovitrap or the container of an ovitrap.

Preferably the ovitrap comprises a communications interface configured to send data to the ovitrap manager; wherein the ovitrap manager is configured to determine a task to instruct to an autonomous vehicle in response to data received from the ovitrap. Preferably the ovitrap comprises one or more sensors and the data comprises data output by the sensors; wherein the sensors comprise at least one of: a presence sensor configured to identify the presence of the container; a weight sensor configured to measure the weight of the container; a level sensor configured to measure the level of a liquid within the container; a vision sensor configured to record images of the content of the container; a larvae sensor configured to sense the presence of larvae and pupae of the water-breeding insect in the container; a leakage sensor configured to identify a leak of liquid from the container.

The larvae sensor may be provided by an optical sensor arranged to count the number of larvae.

In this way the system may be fully automated as the sensors may determine one or more of:
when a container needs to be filled, replaced, cleaned or repositioned and send corresponding data to the ovitrap manager which instructs the automated vehicle to perform the required task.

In some examples one or more ovitrap managers are each part of an ovitrap. In this way it is the ovitraps themselves which instruct the autonomous vehicles to perform one or more tasks.

Preferably at least one ovitrap is an integral ovitrap which is integral to an autonomous vehicle; and the ovitrap manager is configured to send instructions to the autonomous vehicle to move to a desired position, thereby repositioning the integral ovitrap at the desired position. In particular, the autonomous vehicle may comprise a built-in ovitrap, having a container with an upper opening to allow water-breeding insects to enter and lay their eggs therein. The autonomous vehicle may comprise a communications interface to receive data and control the movement of the automated vehicle on the basis of the received data. In this way, the ovitrap manager may instruct the autonomous vehicle to move to a location having a population of water-breeding insects, wait in the region for a specific amount of time until the water-breeding insects have laid eggs in the autonomous vehicle and then destroy the eggs before they develop into adult insects. For example, the vehicle may deposit the contents of the container in an area where there is minimal or no chance for the eggs to develop. Such an automated vehicle provides means to respond rapidly to increased localised numbers of insects.

Preferably at least one ovitrap is a moveable ovitrap and at least one autonomous vehicle comprises: an ovitrap positioning handler arranged to grip and hold the ovitrap such that a moveable ovitrap may be moved to a new location by the autonomous vehicle when instructed by the ovitrap manager.

A “moveable ovitrap” is intended to refer to an ovitrap which is not permanently installed in one location but can be moved by the autonomous vehicle such that it may be readily repositioned. It encompasses ovitraps which have a fixed part installed in a specific location and a removable, replaceable part such as a container which may be mounted on the fixed part. The fixed part may be a base (also referred to herein as a socket) or a frame. Preferably the fixed component comprises an ID reader and the container comprises an ID such that the fixed component can read the ID to determine information about the container, such as the age, capacity etc. The frame may further comprise a communications interface configured to send the information to an ovitrap manager.

Preferably one or more moveable ovitraps comprise a fixed frame; and a removable container; wherein the frame is arranged to hold the removable container such that it can be removed and replaced on the frame by the autonomous vehicle.

Preferably one or more moveable ovitraps comprise a fixed base; and a removable container; wherein the removable container is configured to engage with the base to hold the removable container in place such that the removable container can be removed and replaced on the frame by the autonomous vehicle.

In this way a number of fixed bases/frames may be installed across a region but the containers may be moved between the frames to address varying population numbers of insects across the region. This provides increased flexibility to cope with changing population numbers.

Preferably the system further comprises a vehicle refueling unit configured to refuel the autonomous vehicles wherein the ovitrap manager is configured to instruct the autonomous vehicle to travel to the vehicle refueling unit to refuel; and/or an ovitrap disposal unit configure to dispose of and/or clean a used ovitrap received from an autonomous vehicle wherein the ovitrap manager is configured to instruct an autonomous vehicle to deposit an ovitrap containing eggs at the ovitrap disposal unit; and/or an ovitrap dispenser configured to dispense an ovitrap or a container of an ovitrap wherein the ovitrap manager is configured to instruct an autonomous vehicle to collect the ovitrap of container of an ovitrap from the ovitrap dispenser.

The vehicle refuelling unit, ovitrap disposal unit and ovitrap dispenser may be provided together as an automated vehicle service station, wherein the vehicles move to the service station to refuel and/or dispose of collected used ovitraps or containers and/or pick up fresh ovitraps and/or containers. The automated vehicle service station may be combined with the ovitrap manager in a single unit. The combined unit is also referred to herein as an ovitrap handler, where the ovitrap manager is referred to as an ovitrap section manager.

In another aspect of the invention there is provided an ovitrap comprising: a frame arranged for installation at a fixed location; and a removable container arranged to hold a liquid and collect the eggs of a water-breeding insect; wherein the frame comprises an upper opening arranged to receive the removable container and tapering internal walls arranged to support the removable container in the frame when received in the upper opening.

This provides a low cost structure in which the container may be readily replaced in a straightforward manner by an autonomous vehicle. In particular, the container may simply be placed in the frame from above to hold it in place under the action of gravity. The ovitrap therefore facilitates a more flexible system of managing the population of water-breeding insects since the containers may be moved between a fixed array of frames to follow the changing density of the insect population.

In another aspect of the invention there is provided an ovitrap comprising: a fixed base arranged to be installed at a fixed location; and a removable container arranged to hold a liquid and collect the eggs of a water-breeding insect; wherein the base is configured to engage with the removable container to releasable retain it in place.

The base is also referred to herein as a socket.

This provides a low cost structure in which the container may be readily replaced in a straightforward manner by an autonomous vehicle. In particular, the container may simply be connected to the base from above to hold it in place under the action of gravity. The ovitrap therefore facilitates a more flexible system of managing the population of water-breeding insects since the containers may be moved between a fixed array of bases to follow the changing density of the insect population.

Preferably the removable container comprises a groove extending at least partially around the circumference of the container, the groove arranged to allow the container to be removed from the frame with a corresponding tool. In particular the groove provides a region in which the container may be gripped, a substantially downward facing surface within the groove providing a surface on which a force can be applied to lift the container.

In another aspect of the invention there is provided an ovitrap comprising: a movable container arranged to hold a liquid and collect the eggs of a water-breeding insect, the movable container comprising a groove extending at least partially around the circumference of the container, the groove arranged to allow the container to be moved with a corresponding tool. In particular the groove provides a region in which the container may be gripped, a substantially downward facing surface within the groove providing a surface on which a force can be applied to lift the container.

Preferably the container comprises a base configured to allow the container to be positioned securely on a surface. The base may comprise a flat surface such that the container can stand freely on the surface.

In another aspect of the invention there is provided an ovitrap kit comprising: an ovitrap as described above with a groove extending at least partially around the circumference of the container; and a holding tool having a forked shape with two arms arranged to engage with the groove of the removable container to allow it to be lifted and moved. This provides a straightforward system in which a container may be moved between frames/bases whilst minimizing the risk of dropping or spilling the container. The ovitrap kit therefore facilitates a more flexible system of managing the population of water-breeding insects since the containers may be moved between a fixed array of bases/frames in a straightforward low risk manner to follow the changing density of the insect population.

The arms of the holding tool may be of sufficient length to allow multiple containers to be held between the arms simultaneously. The holding tool may preferably be configured for use by an autonomous vehicle.

In another aspect of the invention there is provided an autonomous vehicle for use in a system for the automated management of a water-breeding insect population, the autonomous vehicle comprising: an integral ovitrap comprising a container arranged to hold a liquid and collect the eggs of a water-breeding insect.

In another aspect of the invention there is provided an autonomous vehicle for use in a system for the automated management of a water-breeding insect population, the autonomous vehicle comprising: an ovitrap positioning handler arranged to grip and hold an ovitrap or a container for an ovitrap such that an ovitrap or container for an ovitrap may be moved to a new location by the autonomous vehicle.

Preferably the autonomous vehicle further includes a container store configured to hold one or more containers arranged to hold a liquid and collect the eggs of a water-breeding insect; wherein the autonomous vehicle is configured to replace the container of an ovitrap with a container held in the fresh container store; wherein the fresh containers held in the container store may be empty or filled with a liquid.

Preferably the autonomous vehicle includes a liquid store arranged to hold liquid for filling a container for use with an ovitrap; and a container filling unit configured to fill a container with liquid from the liquid store; wherein the autonomous vehicle is configured to fill a container with a liquid from the liquid store and replace the container of an ovitrap with a filled container.

Preferably the autonomous vehicle comprises a memory configure to hold data corresponding to preprogramed movement instructions; wherein the autonomous vehicle is configured to move according to the preprogramed movement instructions.

Preferably the autonomous vehicle further comprises a communications interface arranged to receive data, the autonomous vehicle configured to move to an instructed position in response to the received data.

In this way, a mobile ovitrap is provided which can move according to a preset schedule of instructions and/or move as instructed by instructions received in real time. The mobile ovitrap can therefore move to regions where the population of water-breeding insects is high providing a flexible way of managing population densities. The autonomous vehicle may also have a number of additional functionalities such as means to empty and refill the integral container.

In a further aspect of the invention there is provided an autonomous vehicle service station for use in a system for the automated management of a water-breeding insect population, the autonomous vehicle service station comprising: an autonomous vehicle refuelling unit configured to refuel an autonomous vehicle; an ovitrap disposal unit configure to dispose of and/or clean a used ovitrap received from an autonomous vehicle; and an ovitrap dispenser configured to dispense an ovitrap for collection by an autonomous vehicle.

The autonomous vehicle service station is also referred to as an ovitrap handler herein.

In this way a station is provided at which an autonomous vehicle can refuel, exchange used and clean ovitraps and pick up further containers/ovitraps. This reduces the functionality and features required by the autonomous vehicles themselves thus reducing the cost and complexity of a system for the automated management of a water-breeding insect population.

In a further aspect of the invention there is further provided a method for the automated management of a water-breeding insect population, the method comprising: providing one or more ovitraps over a region in which the population of a water-breeding insect is to be managed, where the one or more ovitraps comprise a container arranged to hold a liquid and collect the eggs of a water-breeding insect; instructing one or more autonomous vehicles to perform one or more tasks to administer maintenance of the one or more ovitraps.

In this way, the maintenance of the ovitraps is carried out by autonomous vehicles, thereby reducing or eliminating human involvement. Furthermore, the ovitraps themselves may be cheap and replaceable such that a large number may be deployed to cope with increasing insect populations. They also may be spread across a wide area since the autonomous vehicles travel to the ovitraps such that there is no burden placed on human operators in travelling to maintain the traps. The locations of the ovitraps may also be changed by the autonomous vehicles to address the changing locations of water-breeding insects.

Preferably the one or more tasks comprise one or more of: moving an ovitrap or the container of an ovitrap; refilling an ovitrap with a substance; emptying an ovitrap; drying an ovitrap; removing an ovitrap or the container of an ovitrap; replacing an ovitrap or the container of an ovitrap; recording data relating to an ovitrap; searching for an ovitrap or the container of an ovitrap.

In this way each of the essential actions required to maintain an ovitrap in working order may be carried out in an automated manner by an autonomous vehicle. For example the container of the ovitrap may first be filled to a required level; an insect attract may be added to the container; the ovitrap may then be left for a certain duration of time to allow eggs to be laid in the liquid; the container of the ovitrap may then be emptied such that the eggs are killed and cannot develop into adult insects; the ovitrap may then be cleaned and replenished with liquid.

Preferably the step of providing a plurality of ovitraps comprises: providing a plurality of frames arranged across the region, each frame configured to a support a container arranged to hold a liquid and collect the eggs of a water-breeding insect; the step of instructing the autonomous vehicles comprising: instructing the autonomous vehicles to distribute containers across the frames according to the varying local density of the water-breeding insect population across the region. In particular, if insect population density is higher in a sub-region of the region, the autonomous vehicles are instructed to populate the frames in the sub-region with containers and manage these ovitraps such that more functioning traps are provided in the regions with higher population density. As the distribution of insects across the region changes, the autonomous vehicles can be instructed to redistribute the containers in the frames accordingly. The distribution of insects across the region may be determined automatically by sensors provided in the ovitraps to determine the number of insects being caught at various sampling points across the region.

Preferably the plurality of frames are arranged in a grid pattern.

In another example, the step of providing a plurality of ovitraps comprises: instructing one or more autonomous vehicles to distribute one or more movable containers across the region, each movable container arranged to hold a liquid and collect the eggs of a water-breeding insect, the movable container comprising a groove extending at least partially around the circumference of the container, the groove arranged to allow the container to be moved by the one or more autonomous vehicles.

Preferably the one or more autonomous vehicles are instructed according to an automated schedule of maintenance tasks to be administered across the one or more ovitraps. The schedule may be saved on a memory of a computing unit which could be disposed in the autonomous vehicle, one or more ovitraps or in a remote ovitrap manager. Preferably one or more ovitrap managers are provided and are configured to send instructions to the autonomous vehicles according to the automated schedule of maintenance.

Preferably the method further comprises measuring one or more parameters of the one or more ovitraps with a sensor; and automatically constructing and/or updating the schedule in response to the one or more measured parameters. In this way, the method may be carried out entirely automatically, without human involvement, and may adapt automatically in accordance with the changing population density of insects, as determined by the sensors. For example, if an ovitrap or localised group of ovitraps report a greater number of eggs/larvae/pupae being deposited, for example by means of weight or optical sensors, to the ovitrap manager, the ovitrap manager instructs the autonomous vehicles to populate more frames in the surrounding region with containers. Preferably the sensor comprises one or more of: a presence sensor configured to identify the presence of the container; a weight sensor configured to measure the weight of the container; a level sensor configured to measure the level of a liquid within the container; a vision sensor configured to record images of the content of the container; a larvae sensor configured to sense the presence of larvae and pupae of the water-breeding insect within the container; a leakage sensor configured to identify a leak of liquid from the container.

The method may also include manually inputting data and updating the schedule in response to the manually inputted data. In particular, a human operator may input data manually and the schedule can be updated accordingly. The data may include information on numbers of insects across the region.

The method may further comprise combining data comprising the parameters sensed at the ovitraps in a region to output a map to a user device indicating the positions of the ovitraps and status information comprising the data relating to the ovitraps. In particular, sensor data gathered across the ovitraps may be combined to provide a real time record of insect population densities and/or status information regarding the ovitraps. This combined data may be sent to a user device such as a remote terminal, a pc, a smart phone or a website accessible by the user. The data may be combined into a map providing a visual representation of the insect population densities across a region.

Preferably the method comprises providing a plurality of permanent automated ovitraps which are configured to automatically maintain a desired water level and dispose of collected eggs such that they do not require maintenance to be administered by the one or more autonomous vehicles; and distributing an additional number of administered ovitraps to be administered by the autonomous vehicles; wherein the additional number is selected according to a changing size of the population of the water-breeding insect to be managed. Preferably the plurality of permanent automated ovitraps is arranged in a fixed grid arrangement.

In this way the advantages of both permanent ovitraps and moveable/mobile ovitraps are provided. The minimum number of ovitraps may be provided by an array of permanent automated ovitraps which require little maintenance while further movable ovitraps may be positioned across the region according to changing levels of water-breeding insects. Therefore a flexible, adaptable system is provided.

In a further aspect of the invention there is provided a method for the automated management of a water-breeding insect population comprising: providing an autonomous vehicle comprising an integral ovitrap including a container arranged to hold a liquid and collect the eggs of a water-breeding insect and a communications interface arranged to receive data; instructing the autonomous vehicle via the communications interface to move to specific location for a certain duration of time.

In a further aspect of the invention there is provided a method of providing information to a user regarding activity of water-breeding insects in a specific location; providing a plurality of ovitraps across a region, the ovitraps comprising one or more sensors configured to measure parameters of the ovitraps and a communications interface configured to send data corresponding to the measured parameters; sending the data collected from the ovitraps to a central server; collating the data on the server and sending the data to a user device such that a user can view the data corresponding to a specific location within the region. In this way, a real time record of insect population densities may be recorded and provided to a user based on the data sensed at the ovitraps across a region. This would allow a user to access the data, for example on a website or other software platform, before travelling to a region or sub-region to determine the insect population density in that area. The method may further comprise a step of performing modelling on the collated data to determine likely future trends in the change in insect population density. Preferably the collated data may be displayed in the form of a map on a user device. In certain examples the method further comprises collecting additional data from one or more further sources; and collating the data from the sensors with the additional data.

### DESCRIPTION OF THE DRAWINGS

FIG. 1 illustrates an autonomous mosquito control system.

FIG. 2 illustrates an ovitrap used by the autonomous mosquito control system.

FIG. 3 illustrates an ovitrap used by the autonomous mosquito control system.

FIG. 4 illustrates an ovitrap used by the autonomous mosquito control system.

FIG. 5 illustrates an ovitrap used by the autonomous mosquito control system.

FIG. 6 illustrates a track system to store ovitraps used by the autonomous mosquito control system.

FIG. 7 illustrates an ovitrap used by the autonomous mosquito control system used by the autonomous mosquito control system.

FIG. 8 illustrates a socket for an ovitrap used by the autonomous mosquito control system.

FIG. 9 illustrates a socket used by the autonomous mosquito control system.

FIG. 10 illustrates a tool to hold an ovitrap used by the autonomous mosquito control system.

FIG. 11 illustrates the interface between the autonomous mosquito control system and human operators.

FIG. 12 illustrates a larvae trap as used by the autonomous mosquito control system.

FIG. 13 illustrates an ovitrap handler as used by the autonomous mosquito control system.

FIG. 14 illustrates an autonomous vehicle with an integrated ovitrap as used by the autonomous mosquito control system.

FIG. 15 illustrates an autonomous vehicle used by the autonomous mosquito control system to place and collect ovitraps.

FIG. 16 illustrates an autonomous vehicle used by the autonomous mosquito control system to place and collect ovitraps.

### DETAILED DESCRIPTION

In its most simple form the system for the automated management of a water-breeding insect population comprises at least one ovitrap comprising a container arranged to hold a liquid and collect the eggs of a water-breeding insect, one or more autonomous vehicles; and an ovitrap manager configured to communicate with the one or more autonomous vehicles to instruct an autonomous vehicle to perform one or more tasks to administer maintenance of one or more ovitraps.

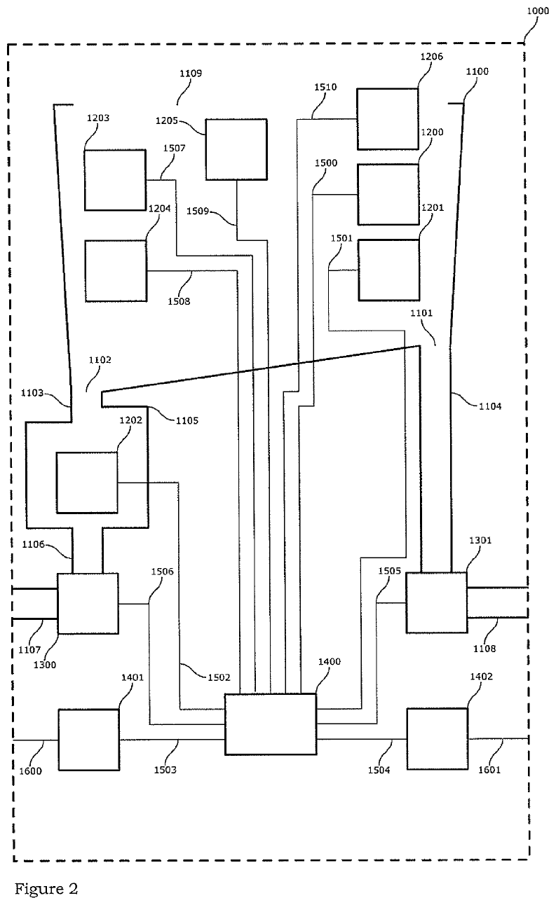

Each ovitrap comprises a container filled with a sufficient volume of water, and preferably an insect attractant, to encourage insects to lay their eggs in the container. Before the eggs can develop into adult insects the autonomous vehicles are instructed to dispose of the liquid and eggs collected therein, either by depositing the liquid in a region where the eggs will die or drying the ovitrap out such that the eggs die and cannot develop. There are several possible structures of ovitrap, as illustrated in FIGS. 2, 3, 4, 5, 7, 12 and 14.

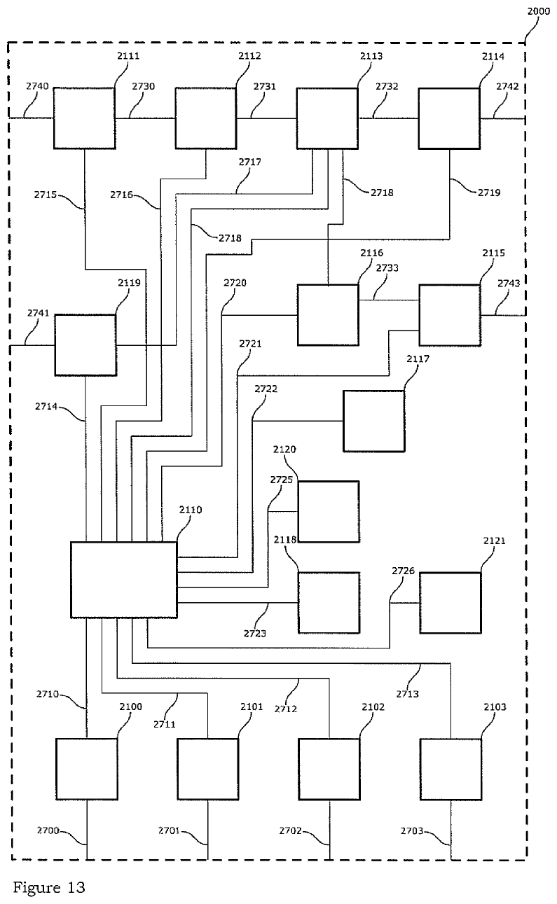

An exemplary system comprises a number of ovitraps positioned across a region in which the population of water-breeding insects is to be managed. Ovitrap managers are disposed throughout the region with each responsible for instructing a number of vehicles to manage the ovitraps in a sub-region surrounding that ovitrap manager. The ovitrap managers advantageously have a hierarchical structure through which they can communicate to share data regarding the status of the ovitraps and autonomous vehicles and instruct each other to perform tasks. In this example, the lowest level ovitrap manager is an ovitrap section section manager. This is integrated in an ovitrap handler which acts as an automated vehicle service station, providing refuelling facilities, a store of containers and a disposal area for container containing liquid and eggs to be emptied or disposed of. The ovitrap handler is illustrated in FIG. 13. In the level above the ovitrap section manager is a local manager. The local managers are connected to each other and each ovitrap handler. In the level of the hierarchy above the local manager there are a number of global managers, each connected to a number of local mangers to instruct them to perform tasks, as well as being connected to each other. All units in the network can share data. By providing a meshed network of ovitrap managers in this way, the system is fault resistant and continue to operate even if one or more mangers fails, as will now be described in more detail.

Overall Hierarchy of the Autonomous Mosquito Control System

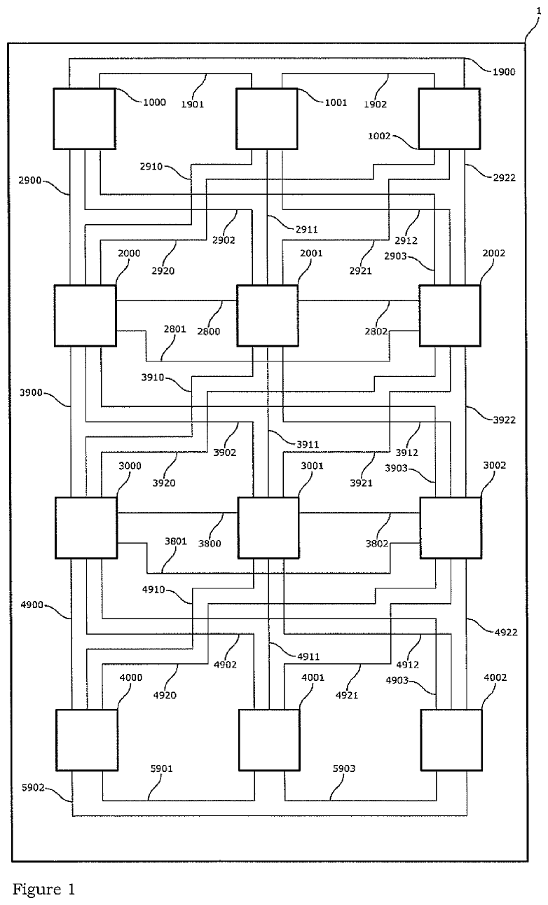

FIG. 1 illustrates an autonomous mosquito control system 1. An ovitrap 1000 is connected via a connection 1901 with an ovitrap 1001. The ovitrap 1001 is connected via a connection 1902 with an ovitrap 1002. The ovitrap 1000 is connected via a connection 1900 with the ovitrap 1002.

An Ovitrap handler 2000 is connected via a connection 2900 with the ovitrap 1000. The ovitrap handler 2000 is connected via a connection 2910 with the ovitrap 1001. As will be described, the ovitrap handler may also be described as an autonomous vehicle service station. The ovitrap handler 2000 is connected via a connection 2920 with the ovitrap 1002. An ovitrap handler 2001 is connected via a connection 2902 with the ovitrap 1000. The ovitrap handler 2001 is connected via a connection 2911 with the ovitrap 1001. The ovitrap handler 2001 is connected via a connection 2921 with the ovitrap 1002. An ovitrap handler 2002 is connected via a connection 2903 with the ovitrap 1000. The ovitrap handler 2002 is connected via a connection 2912 with the ovitrap 1001. The ovitrap handler 2002 is connected via a connection 2922 with the ovitrap 1002.

The ovitrap handler 2000 is connected via a connection 2800 with the ovitrap handler 2001. The ovitrap handler 2000 is connected via a connection 2801 with the ovitrap handler 2002. The ovitrap handler 2001 is connected via a connection 2802 with the ovitrap handler 2002.

A local manager 3000 is connected via a connection 3900 with the ovitrap handler 2000. The local manager 3000 is connected via a connection 3910 with the ovitrap handler 2001. The local manager 3000 is connected via a connection 3920 with the ovitrap handler 2002. An ovitrap handler 3001 is connected via a connection 3902 with the ovitrap handler 2000. The local manager 3001 is connected via a connection 3911 with the ovitrap handler 2001. The local manager 3001 is connected via a connection 3921 with the ovitrap handler 2002. A local manager 3002 is connected via a connection 3903 with the ovitrap handler 2000. The local manager 3002 is connected via a connection 3912 with the ovitrap handler 2001. The local manager 3002 is connected via a connection 3922 with the ovitrap handler 2002.

The local manager 3000 is connected via a connection 3800 with the local manager 3001. The local manager 3000 is connected via a connection 3801 with the local manager 3001. The local manager 3001 is connected via a connection 3802 with the local manager 3002.

A global manager 4000 is connected via a connection 4900 with the local manager 3000. The global manager 4000 is connected via a connection 4910 with the local manager 3001. The global manager 4000 is connected via a connection 4920 with the local manager 3002. A global manager 4001 is connected via a connection 4902 with the local manager 3000.

The global manager 4001 is connected via a connection 4911 with the local manager 3001. The global manager 4001 is connected via a connection 4921 with the local manager 3002. A global manager 4002 is connected via a connection 4903 with the local manager 3000. The global manager 4002 is connected via a connection 4912 with the local manager 3001. The global manager 4002 is connected via a connection 4922 with the local manager 3002. The global manager 4000 is connected via a connection 5901 with the global manager 4001. The global manager 4000 is connected via a connection 5902 with the global manager 4002. The global manager 4001 is connected via a connection 5903 with the global manager 4002.

The system in FIG. 1 uses three for the number of ovitraps 1000, 1001 and 1002, the number of ovitrap handlers 2000, 2001 and 2002, the local managers 3000, 3001 and 3002 and the global managers 4000, 4001 and 4002. However, it can be any number above zero for each element. The functionality of the ovitrap handlers 2000, 2001 and 2002 (described in detail below in reference to FIG. 13) can be integrated into the ovitraps 1000, 1001 and 1002 when required.

The use of three units on each level of the hierarchy allows for fault tolerant behaviour to be implemented on each level. The mosquito control system 1 will be able to work in a disaster tolerant manner when at least three global managers 4000, 4001 and 4002 are operational in the system. When only one local manager 3000, 3001 or 3002 is operational at a site, the site itself will not be able to detect all faults itself but the global managers 4000, 4001 and 4002 will still be able to detect some faults. When at least three global managers 4000, 4001 and 4002 are operational, the autonomous mosquito control system 1 can operate disaster tolerant. When at least two global managers 4000, 4001 and or 4002 are operational, the autonomous mosquito control system 1 can operate disaster tolerant with the limitation that malfunctions on the level of the global managers 4000, 4001 or 4002 are not detectable. The autonomous mosquito control system 1 will operate but without disaster tolerance when only one global manager 4000, 4001 or 4002 is operational.

The global managers 4000, 4001 and 4002 exchange status information of the autonomous mosquito control 1 via the connections 5901, 5902 and 5903 so that the status information available to each of the global managers 4000, 4001 and 4002 is as current as it could be. The global managers 4000, 4001 and 4002 act in a global manner having all the information available of all components of the autonomous mosquito control system 1.

The local managers 3000, 3001 and 3002 exchange status information via the connection 3800, 3801 and 3802 so that the status information available to each of local managers 3000, 3001 and 3002 is as current as it could be. When one of the local managers 3000, 3001 or 3002 is not able to connect to at least one of the global managers 4000, 4001 or 4002, it will first try to reach any of the global managers 4000, 4001 or 4002 via one of the other local managers 3000, 3001 or 3003. If none of the local managers 3000, 3001 or 3002 is able to connect to any of the global managers 4000, 4001 or 4002, the local managers 3000, 3001 and 3002 take over the task of the global managers for the group of connected local managers 2000, 2001 and 2002. As soon one of the local managers 3000, 3001 or 3002 can establish a connection to one of the global managers 4000, 4001, or 4002, the task of a global manager is handed over to the real global managers 4000, 4001 and 4002 again. This will included a status update send to the global managers 4000, 4001 and/or 4002.

The ovitrap handlers 2000, 2001 and 2002 exchange status information via the connections 2800, 2801 and 2802 so that the status information available to each of the ovitrap handlers 2000, 2001 or 2002 is as current as possible. When one of the ovitrap handlers 2000, 2001 or 2002 is not able to connect to at least one of the assigned local managers 3000, 3001 or 3002, it will first try to reach any of the assigned local managers 3000, 3001 or 3002 via one of the other ovitrap handlers 2000, 2001 or 2002. If none of the ovitrap handlers 2000, 2001 and 2002 is able to connect to any of the assigned local managers 3000, 3001 or 3002, the group of ovitrap handlers 2000, 2001 and 2002 will take over the task of a local manager 3000, 3001 or 3002. When one of the ovitrap handlers 2000, 2001 or 2002 is able to connect to one of the assigned local managers 3000, 3001 or 3002, the local manager 3000, 3001 or 3002 will be updated and the task of a local manager is handed over to the real local managers again.

The ovitraps 1000, 1001 and 1002 exchange status information via the connections 1901, 1902 and 1900 so that all ovitraps 1000, 1001 and 1002 of a group share the same status information. When one ovitrap 1000, 1001 or 1002 is not able to connect to at least one of the assigned local managers 2000, 2001 or 2002, it will try to connect to a local manager 2000, 2001 or 2002 via the other ovitraps 1000, 1001 or 1002. If the ovitraps 1000, 1001 and 1002 are not able to connect to at least one of the assigned ovitrap handlers 2000, 2001 and 2002, the ovitraps 1000, 1001 and 1002 will take over the task of the ovitrap handlers 2000, 2001 and 2002. When one of the ovitraps 1000, 1001 or 1002 is able to connect to one of the ovitrap handlers 2000, 2001 or 2002, the task of the ovitrap handlers is handed over to the real ovitrap handlers 2000, 2001 and 2002.

The scale of the autonomous mosquito control system 1 can be extended to be of real global reach. The scale of the autonomous mosquito control system 1 can be limited to a region only. A region can be defined to contain one or more continents. A region can be defined to contain one or more countries. A region can be defined to contain one or more states forming a country. A region can be defined to contain one or more districts forming a state. A region can be defined to contain one or more cities or villages. On smaller definitions of a region, it is recommended to include the functionality of a global manager 4000, 4001 or 4002 into the local manager 3000, 3001 or 3002.

Each global manager 4000, 4001 or 4002 can be connected to one or more local managers 3000, 3001 or 3002. An individual local manager 3000, 3001 or 3002 does not have to be connected to all global managers available to the autonomous mosquito control system 1. The global managers 4000, 4001 and 4002 exchange also the status information from local managers 3000, 3001 or 3002 not connected to an individual global manager 4000, 4001 or 4002. As such, each global manager 4000, 4001 or 4002 will have always the status information of all local managers 3000, 3001 or 3002 available known the autonomous mosquito control system 1. The failure of an individual global manager 4000, 4001 or 4002 will not impact the functionality of the autonomous mosquito control system 1 as the other global managers 4000, 4001 or 4002 will take over the work from a failed global manager 4000, 4001 or 4002. The autonomous mosquito control system 1 will stay operational as long as at least one of the global managers 4000, 4001 or 4002 will stay operational.

A local manager 3000, 3001 or 3002 is normally assigned to a site. A site can have any number of ovitrap handlers 2000, 2001 or 2002. A single ovitrap handler 2000, 2001 or 2002 can have any number of ovitraps 1000, 1001 or 1002 assigned. A single site can be operated with a single local manager 3000, 3001 or 3002. Fault-tolerant operation of a site requires at least three local managers 3000, 3001 and 3002 assigned to a site. The connection used to exchange status information can also be used to ex-change commands.

Permanent Automated Ovitrap

FIG. 2 shows a permanent automated ovitrap 1000 that may be used by the autonomous mosquito control system 1 in addition to the ovitraps to be serviced by the autonomous vehicles. As described above, by using a combination of permanent automated ovitraps and moveable ovitraps a high degree of flexibility in the system can be achieved.

The permanent ovitrap comprises a container 1100 shaped so that it can contain a liquid, for example water, with an opening 1109 on its top shaped so that the targeted insect species is able to access the walls of it and the surface of the liquid stored in it. The container 1100 has an opening 1101 on its bottom located so that liquid flowing into the container 1100 via the opening 1101 will flow down to a second opening 1102 while flushing the bottom of the container. The opening 1102 is located so at the bottom of the container 1100 that all liquid stored in the container 1100 will be able to leave the container 1100 only by the use of gravity. The opening 1102 is connected via a pipe 1103 with a small chamber 1105. The chamber 1105 is located underneath the container 1100 so that all water leaving the container 1100 via the opening 1102 can reach the chamber 1105 only with the help of gravity. A level sensor 1202 is located inside the chamber 1105 so that it can sense the presence of a liquid inside the chamber 1105 at its position. The chamber 1105 is connected via a pipe 1106 with a control element 1300. The control element 1300 is connected to a pipe 1107. The pipe 1107 is connected to a disposal system to dispose the liquid which might contain insect eggs, insect larvae and insect pupae in a way to make sure that no adult insects emerging will be able to leave the disposal system alive. The opening 1101 is connected to a pipe 1104. The pipe 1104 is connected to a control element 1301. The control element 1301 is connected to a pipe 1108. The pipe 1108 is connected to a liquid supply system able to provide the liquid for the ovitrap to attract insects. The liquid can be normal water. The liquid might already contain the attractant used to increase the attractiveness of the container 1100 for the targeted insect species. A level sensor 1200 is located inside the container 1100 so that it can sense the presence of a liquid at its position. A level sensor 1201 is located inside the container 1100 so that it can sense the presence of a liquid at its position. The liquid level sensed by the level sensor 1200 is above the liquid level sensed by the level sensor 1201. A level sensor 1206 is located inside the container 1100 so that is can sense the presence of a liquid at its position. The liquid level sensed by the level sensor 1206 is above the liquid level sensed by the level sensor 1200. A dosing unit 1205 is located at the container 1100 so that it can provide a substance for the liquid inside the container 1100. The substance is known to attract the targeted insect species. A vision sensor 1203 is located at the container so that it can provide visual images of the content of the container 1100. A larvae sensor 1204 is located at the container 1100 so that it is able to sense developed larvae and pupae. The level sensor 1206 is connected via a connection 1510 with an ovitrap manager 1400. The level sensor 1200 is connected via a connection 1500 with the ovitrap manager 1400. The level sensor 1201 is connected via a connection 1501 with the ovitrap manager 1400. The dosing unit 1205 is connected via a connection 1509 with the ovitrap manager 1400. The vision sensor 1203 is connected via a connection 1507 with the ovitrap manager 1400. The larvae sensor 1204 is connected via a connection 1508 with the ovitrap manager 1400. The level sensor 1202 is connected via a connection 1502 with the ovitrap manager 1400. The control element 1300 is connected via a connection 1506 with the ovitrap manager 1400. The control element 1301 is connected via a connection 1505 with the ovitrap manager 1400. An interface manager 1401 is connected via a connection 1503 with the ovitrap manager 1400. The interface manager 1401 is connected to a connection 1600. The interface manager 1401 communicates via the connection 1600 with the ovitrap handlers (e.g. 2000, 2001, 2002) it is assigned to. An interface manager 1402 is connected via a connection 1504 with the ovitrap manager 1400. The interface manager 1402 is connected to a connection 1601. The interface manager 1402 communicates via the connection 1601 with the ovitraps (e.g. 1001, 1002, 1003) it is assigned to.

The level sensors 1200, 1201, 1202 and 1206 report in a binary way the level of the liquid contained in the container 1100. The level sensors 1200, 1201, 1202 and 1206 report if the liquid level inside the container 1100 is higher or lower as their physical position inside the container 1100. The four water level sensors 1200, 1201, 1202 and 1206 can be replaced by a single level sensor which is able to give a continuous reading of the liquid level inside the container 1100.

The level sensor 1206 reports when the liquid in the container 1100 reached a level close to the maximum the container 1100 can hold. The level sensor 1200 reports when the liquid in the container 1100 reached the ideal operational level. The level sensor 1201 reports when the liquid in the container 1100 reached the minimum operational level. The level sensor 1202 reports when the liquid in the container 1100 reached a level indicating that the container can be considered empty.

The opening 1109 can be shaped so that insects species not targeted avoid the container or are not able to enter the opening 1109.

The permanent automated ovitrap 1000 therefore does not need human intervention or maintenance provided by an autonomous vehicle but can self-manage its functioning. This type of ovitrap may therefore be provided in a grid, providing a constant basic minimum level of insect population management within a region. A flexible number of autonomous vehicle managed ovitraps may then be added according to demand to meet the changing requirements as insect population density and location changes.

Operation of a Permanent Automated Ovitrap

Default State

The container 1100 of the ovitrap 1000 does not contain any liquid. The control element 1301 blocks the inflow of liquid. The ovitrap manager 1400 will instruct the control element 1300 to allow the outflow of liquid from the container 1100 as long as the level sensor 1202 reports a liquid level higher as its position. The control element 1300 will be instructed by the ovitrap manager 1400 to stop the flow of any liquid when the level sensor 1202 reports that the liquid level inside the container 1100 is below the position of the level sensor 1202.

Filling State

The ovitrap manager 1400 instructs the control element 1300 to block all liquid flowing out of the container 1100. The ovitrap manager 1400 instructs the control element 1301 to allow the flow of liquid into the container 1100. The ovitrap manager 1400 waits then a predefined time for the information from the level sensor 1201 that its level was reached. If this level is not reached within a predefined time, an alarm can be generated and send via the interface manager 1401 to the connected ovitrap manager 2000. When the information arrived from the level sensor 1201, the ovitrap manager 1400 will then wait for the information from the level sensor 1200 that its level was reached. If this level is not reached within a predefined time, an alarm can be generated and send via the interface manager to the ovitrap handlers 2000, 2001 and/or 2002. When the level sensor 1200 provides the information that its level has been reached, the ovitrap manager 1400 instructs the control element 1301 to block the flow of any liquid into the container 1100.

Collecting State

The ovitrap manager 1400 waits for a predefined time during which it monitors the levels reported from the level sensors 1201 and 1206. When the level sensor 1206 reports that the liquid level inside the container 1100 reached its position, the ovitrap manager 1400 instructs the control element 1300 to allow the flow of liquid out of the container 1100. The ovitrap manager 1400 will wait until the level sensor 1200 reports that the liquid level in the container has fallen below its position. The ovitrap manager 1400 will then instruct the control element 1300 to block the further outflow of liquid from the container 1100. When the level sensor 1201 reports that the liquid level inside the container 1100 falls below its position, the ovitrap manager 1400 will instruct the control element 1301 to allow the inflow of liquid into the container. The ovitrap manager 1400 will wait until the level sensor 1200 reports that the liquid level in the container reached its position and then instruct the control element 1301 to block the inflow of the liquid into the container 1100. This behaviour will make sure that the liquid level inside the container stays between the levels defined by the position of the level sensors 1201 and 1206. The liquid level will rise e.g. during rain falls. The liquid level will fall e.g. longer spells of sun shine or animals drinking the liquid from the container 1100.

Increasing Attractiveness

Some insect species are attracted by specific substances. To increase the attractiveness of the ovitrap 1000, one or more of these substances can be stored inside the dosing unit 1205. The ovitrap manager 1400 will instruct the dosing unit 1205 to release a predefined amount of these substances into the liquid inside of the container 1100 when required.

Larvae Detection

A larvae sensor 1204 can be used to detect the presence of larvae inside of container 1100. The presence of larvae can be used as an indicator to end the collection state of the ovitrap 1000 and switch the ovitrap 1000 into its flushing state.

Vision Sensor

The vision sensor 1203 provides an image or a video of the inside of the container 1100 remotely. One or more images can be send via the interface manager 1401 to the connected ovitrap handlers 2000, 2001 and/or 2002. The image can be used to detect the presence of larvae inside of the container 1100. The vision sensor 1203 can be used to monitor the litter collecting over time in the container 1100. When the amount of litter detected inside the container 1100, the ovitrap manager 1400 will send a notification to the ovitrap handlers 2000, 2001 and/or 2002.

Flushing State

The ovitrap manager 1400 instructs the control element 1301 to block any flow of liquid into the container 1100. The ovitrap manager 1400 instructs the control element 1300 to allow the outflow of liquid from the container 1100. The ovitrap manager 1400 waits then for the information from the level sensor 1202 that the liquid level fell below its position inside the container 1100. If the information that the liquid level fell below the position of the level sensor 1202 does not arrive within a predefined time, the ovitrap manager 1400 can send an notification via the interface manager 1401 to the assigned ovitrap handler 2000. If the information that the liquid level fell below the position of the level sensor 1202 but at least one of the level sensors 1200, 1201 or 1206 still reports that the liquid stands above their position, the ovitrap manager 1400 can send a notification via the interface manager 1401 to the assigned ovitrap handler 2000. In this case, it is likely that the opening 1102 was blocked by some litter.

Drying State

The ovitrap manager 1400 instructs the control element 1301 to block all inflow of liquid into the container 1100. The ovitrap manager instructs the control element 1300 to allow the outflow of liquid from the container 1100 when the level sensor 1202 reports a liquid level higher than the position of the level sensor 1202. When the liquid level reported by the level sensor 1202 stays longer above this level, a notification can be generated and send to the ovitrap manager 2000 via the interface manager 1401. Any information given by one of the level sensors 1200, 1201 or 1206 that the level of the liquid inside the container 1100 is above their position, is considered an error and the ovitrap manager 1400 will send a notification via the interface manager 1401 to the ovitrap handler 2000.

Cycling

After the start of operation, the ovitrap 1100 will continuously go through the cycle of filling, collecting, flushing and drying. When the ovitrap 1100 is instructed to become inactive it will go into the drying state.

Error Conditions

It is an error when the liquid level reported by level sensor 1200 is not reached within a predefined time when the control element 1301 is activated.

It is an error when the liquid level does not fall within a predefined time below the levels reported by the level sensors 1206, 1200, 1201 and 1202 when the control element 1300 is activated.

Moveable Ovitrap Including a Frame and Container

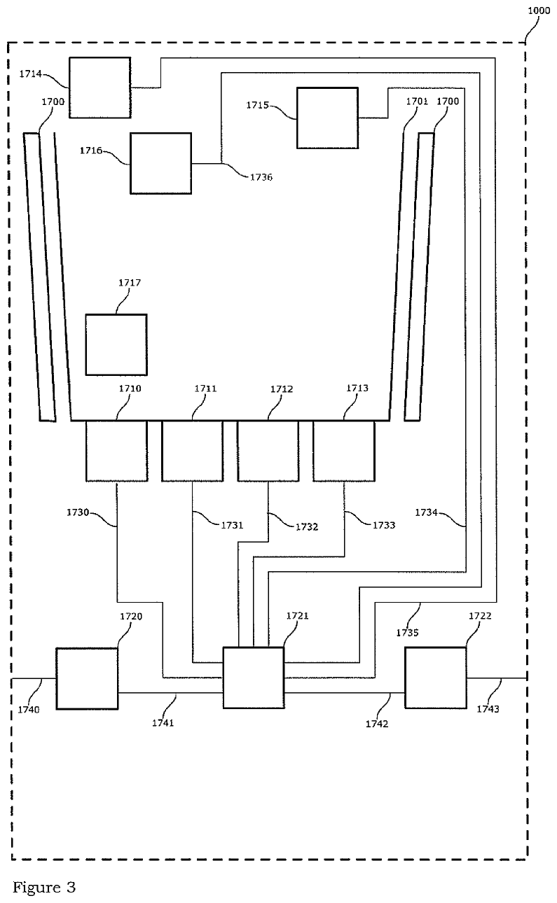

FIG. 3 shows an alternative implementation of an ovitrap 1000 to be used by the autonomous mosquito control system 1. The ovitrap 1000 of FIG. 3 is a moveable ovitrap to be managed by an autonomous vehicle.

The ovitrap of FIG. 3 includes a frame 1700 shaped so that a container 1701 can be moved in from top but will be stopped from leaving the frame 1700 on its bottom. This is typically achieved by making the top of the frame 1700 wider than its bottom. The bottom of the frame 1700 has to be shaped so that any liquid leaving a container 1701 will not collect. The container 1701 has its outer shape adjusted so that it can be moved in from top into the frame 1700 but also so that it can be moved out towards the top without excessive force. The container 1701 has a machine readable ID 1717 attached to it. The frame 1700 has an ID sensor 1710 attached so that it can read the ID 1717 of the container. The ID sensor 1710 is placed so that it does not interfere with the movement of the container 1701 when inserted or removed. The ID sensor 1710 transmits the ID 1717 of the container 1701 when inserted into the frame 1700 to the ovitrap manager 1721. The ovitrap manager 1721 transmits the ID 1717 via the interface manager 1720 to the ovitrap handler 2000, 2001 or 2002. The frame 1700 has a presence sensor 1711 attached so that it can sense the presence of the container 1701 when inserted. The presence sensor 1711 is placed so that it does not interfere with the movement of the container 1701 when inserted or removed. The frame 1700 has a weight sensor 1712 attached so that it can sense the weight of the container 1701 when inserted. The weight sensor 1712 is placed so that it does not interfere with the movement of the container 1701 when inserted or removed. The frame 1700 has a leakage sensor 1713 attached so that it can sense leakage from the container 1701. The leakage sensor 1713 is placed so that it does not interfere with the movement of the container 1701 when inserted or removed. The frame 1700 has a dosing unit 1716 attached so that it does not interfere with the movement of the container 1701 when inserted or removed. The dosing unit 1716 provides an attractant to be added to the liquid contained in the container 1701. The frame 1700 has a vision sensor 1714 attached so that it does not interfere with the movement of the container 1701 when it is inserted or removed. The vision sensor 1714 is connected via a connection 1735 with an ovitrap manager 1721. The vision sensor 1714 provides an optical image of the content of the container 1701. The optical image can be transmitted via the connection 1735 to the ovitrap manager 1721. The ovitrap manager 1721 can transmit the image of the ovitrap via the interface manager 1720 to the ovitrap handler 2000, 2001 or 2002. The dosing unit 1716 is connected via a connection 1736 with the ovitrap manager 1721. A larvae sensor 1715 is installed so that it can detect larvae in the container 1701. The larvae sensor 1715 is connected via a connection 1734 with the ovitrap manager 1721. The leakage sensor 1713 is connected via a connection 1733 with the ovitrap manager 1721. The weight sensor is connected via a connection 1732 with the ovitrap manager 1721. The presence sensor 1711 is connected via a connection 1731 with the ovitrap manager 1721. The ID sensor 1710 is connected via a connection 1730 with the ovitrap manager 1721. The ovitrap manager 1721 is connected via a connection 1741 with the interface manager 1720. The interface manager 1720 is connected to a connection 1740. The interface manager 1720 communicates via the connection 1740 with the ovitrap handlers (e.g. 2000, 2001, 2002) it is assigned to. A interface manager 1722 is connected via a connection 1742 with the ovitrap manager 1721. The interface manager 1722 is connected to a connection 1743. The interface manager 1722 communicates via the connection 1743 with the ovitraps (e.g. 1001, 1002, 1003) it is assigned to. The presence sensor 1711 notifies the ovitrap manager 1721 when a container 1701 is inserted into the frame 1700. The presence sensor 1711 notifies the ovitrap manager 1721 when a container 1701 is removed from the frame 1700. The notifications send by the presence sensor 1711 are forwarded by the ovitrap manager 1721 via the interface manager 1720 to the ovitrap handler 2000. The weight sensor 1712 notifies the ovitrap manager 1721 via the connection 1732 when the weight of the inserted container 1701 changes together with the current weight of the container 1701. The ovitrap manager 1721 notifies the ovitrap handler 2000 of the change in weight via the interface manager 1720. The leakage sensor 1713 notifies the ovitrap manager 1721 via the connection 1733 of a detected leak of the container 1701. The ovitrap manager 1721 notifies the ovitrap handler 2000 of the detected leak via the interface manager 1720. The ovitrap manager 1721 notifies all other connected ovitraps 1000 via the interface manager 1722 of any status change of the ovitrap 1000.

FIG. 3 illustrates an ovitrap 1000 for temporary or permanent use using the container 1701.

The ovitrap manager 1721 instructs the dosing unit 1716 via the connection 1736 to add a given amount of attractant stored in the dosing unit 1716 to the content of the container 1701 when required. The attractant added to the container 1701 via the dosing unit 1716 can be solid or liquid. An extract made from hay is known to be a good attractant for certain mosquito species. The extract containing pheromones attracts females to deposit more eggs inside the container 1701.

The change of weight reported by the weight sensor 1712 can be used as in indicator. Increased weight indicates additional water entered the container 1701 especially during rainfalls. Additional weight reported by the weight sensor 1712 could also indicate that objects fell onto the container 1701. An external intervention is required for the proper operation of the ovitrap 1000 in such cases. The weight reports are part of the status information of an ovitrap 1000 equipped with the weight sensor 1712.

The ovitrap manager 1721 will monitor the time the container 1701 will stay in position. When the container 1701 stays longer than a predefined time in position a notification will be send by the ovitrap manager 1721 to the assigned ovitrap handler 2000, 2001 or 2002. The removal of the container 1701 is required then to avoid breeding of insects inside the container 1701 in such cases.

When the presence sensor 1711 reports the absence of the container 1701 when the container 1701 should be present, the ovitrap manager 1721 will send a notification to the assigned ovitrap handler 2000, 2001 or 2002 and the connected ovitraps 1000, 1001 or 1002. The unexpected absence of the container 1701 is an error condition which has to be handled by the ovitrap handler 2000, 2001 or 2002.

Ovitrap Including a Container to be Placed on a Surface

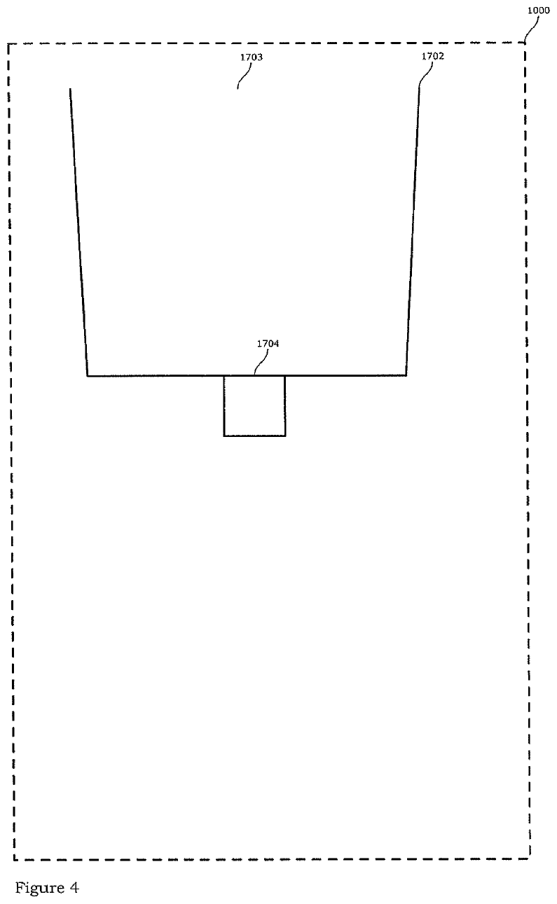

FIG. 4 illustrates an alternative implementation of the ovitrap 1000. The ovitrap of FIG. 4 includes a container which is arranged to be placed on a surface in a position by an autonomous vehicle. It therefore represents a very cost effective type of ovitrap, useful for covering large regions. The ovitrap 1000 in FIG. 4 includes a container 1702 shaped so that it can be placed on a surface. A machine readable ID 1704 is attached to the container 1702. The inner part of the container 1702 is shaped so that it can hold a liquid like water for a given period of time without leaking. The container 1702 has an opening 1703 on its top. The opening 1703 is shaped so that insects of the targeted species can access the side walls above the liquid and also the surface of the liquid stored inside the container 1702.

The container 1702 can be made out of any material able to hold water for a predefined period of time. Biocompostable material like a coconut can be used for this purpose.

The ID 1704 has to be unique for at least the location it is used in. A more sophisticated ID 1704 will be unique for the whole autonomous mosquito control system 1.

The shape of the container 1702 when seen from top can be either round or it can have corners.

The container 1702 is placed at a predefined location for a predefined period of time. The liquid stored inside the container 1702 will attract water breeding insects like mosquitoes to deposit their eggs. The container 1702 will be removed from the predefined location after the predefined time is over.

Ovitrap Container Including a Groove to Facilitate Movement

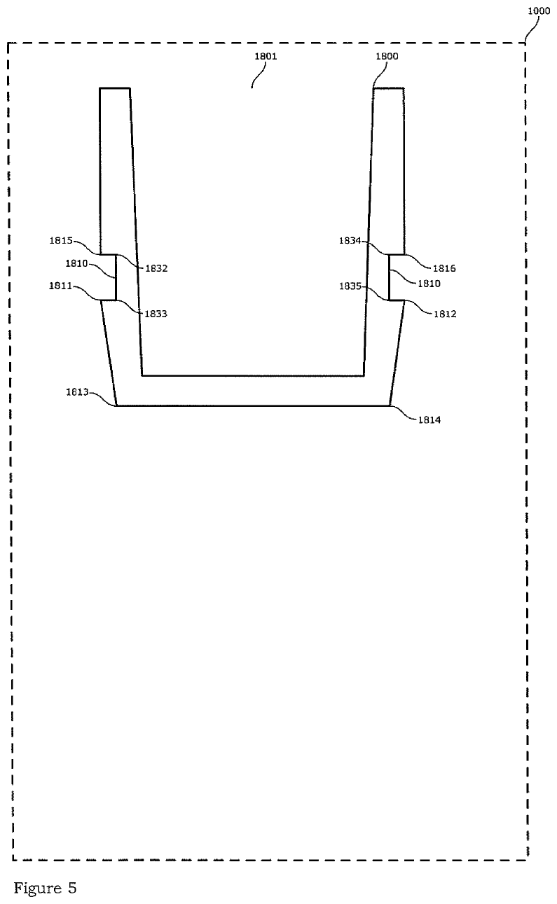

FIG. 5 illustrates a container which can be used with the ovitrap 1000 of FIGS. 2 to 4. The container 1800 includes an opening 1801 on its top. The inner part of the container 1800 is shaped so that it can hold a liquid like water for a predefined period of time. An opening 1801 on top of the container 1800 is shaped so that insects of the targeted species can access the side walls of the container 1800 and the surface of the liquid stored in it. A groove 1810 on the outer side wall of the container 1800 is placed either all around the side walls of container 1800 or partially. The groove 1810 has an upper corner 1815 on the left side of the container 1800. The groove 1810 has an upper corner 1816 on the right side of the container 1800. The groove 1810 has a lower corner 1811 on the left side of the container. The groove 1810 has a lower corner 1812 on the right side of the container. The groove 1810 has an upper inner corner 1832 on the left side of the container 1800. The groove 1810 has a lower inner corner 1833 on the left side of the container 1800. The groove 1810 has an upper inner corner 1834 on the right side of the container 1800. The groove 1810 has a lower inner corner on the right side of the container 1800. The distance between the inner corner 1832 and the inner corner 1834 is less than the distance between the upper corner 1815 and the upper corner 1816. The distance between the inner corner 1833 and the inner corner 1835 is less than the distance between the lower corner 1811 and the lower corner 1812. The size of the groove 1810 has to be adjusted so that the tool used to lift the container 1800 fits into the groove 1810 and it is not damaged by moving the container 1800 and also the container 1800 is not damaged by the movement and by the tool used to hold the container 1800. The side walls of the container 1800 below the groove 1810 are slanted so that the distance between the lower corner 1811 at the bottom side of the groove 1810 on one side of the container 1800 and a lower corner 1812 at the bottom side of the groove 1810 on the other side of the container 1800 is larger than the distance of a corner 1813 at the bottom of the container 1800 and a lower corner 1814 at the other side of the bottom of the container 1800. The distance between the corner 1811 and the corner 1813 is the same as the distance between the corner 1812 and the corner 1814 with some tolerance. The surface between the corner 1811 and the corner 1813 is even with some tolerance. The surface between the corner 1812 and the corner 1814 is even with some tolerance. The side wall below the groove 1810 can be used by a tool to the hold the container 1800 and/or to move it around. The surface of the outside bottom of the container 1800 between the corner 1813 and the corner 1814 is even with some tolerance. The container 1800 can be placed on any flat surface. Any number of grooves like the groove 1810 can be used on the side walls of the container 1800.

The distance between the corner 1815 and the corner 1816 is close to the distance between the corner 1811 and the corner 1812. The shape of the container 1800 when seen from top can be either round or it can have corners.

The container 1800 can be made out of any material which does not repel mosquitoes. Plastic is a possible material just like concrete. The container 1800 can also be made out of biocompostable material. Coconuts can be shaped like the container 1800 and be used as long they do not leak. Coconuts can be composted after use. The container 1800 can be used instead of the container 1701 in FIG. 3. The container 1800 can be equipped with the ID 1704 just as the container 1702.

Track System for Holding Containers with a Groove

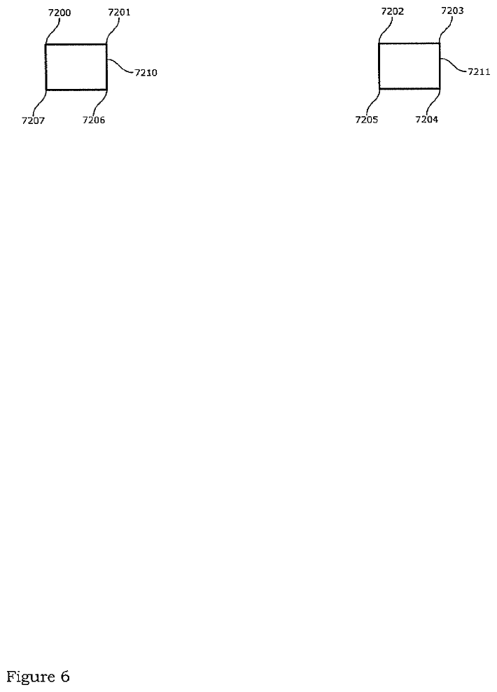

FIG. 6 illustrates a track system, shown end on, consisting of a straight beam 7210 and a straight beam 7211. The beam 7210 has a corner 7201. The beam 7210 has a corner 7200. The beam 7210 has a corner 7207. The beam 7210 has a corner 7206. The beam 7211 has a corner 7202. The beam 7211 has a corner 7201. The beam 7211 has a corner 7204. The beam 7211 has a corner 7205. The distance between the corner 7200 and the corner 7207 is equal or less than the distance between the corner 1815 and the corner 1811. The distance between the corner 7201 and the corner 7206 is equal or less than the distance between the corner 1815 and the corner 1811. The distance between the corner 7202 and the corner 7205 is equal or less than the distance between the corner 1815 and the corner 1811. The distance between the corner 7203 and the corner 7204 is equal or less than the distance between the corner 1815 and the corner 1811.

The beam 7210 and the beam 7211 are mounted so that they are in parallel on the same level, a container 1800 can be pushed in between so that the beam 7210 slides into the groove 1810 on the left side of the container 1800 and the beam 7211 slides into the groove 1810 on the right side of the container. When the beams 7210 and 7211 are orientated horizontal, several containers 1800 can be moved in. When both ends of the track are closed, the containers 1800 are not able to leave the track. The container 1800 can be stored in the track system so that the opening 1801 is above the track system or below. When the opening 1801 is above the track system, the containers 1800 will not lose their content. When the opening 1801 is below the track system, empty containers 1800 will stay empty. When the opening 1801 is below the track system, filled containers 1800 will lose their content. When the opening 1801 is below the track system, the containers 1800 can be cleaned from below with all the unwanted objects falling down after being washed out by a jet of liquid or pressured gas. A liquid like water with or without detergents is used for this purpose. Important is that the liquid used does not act as a repellent of the targeted insect species.

An Alternative Container for Use with an Ovitrap

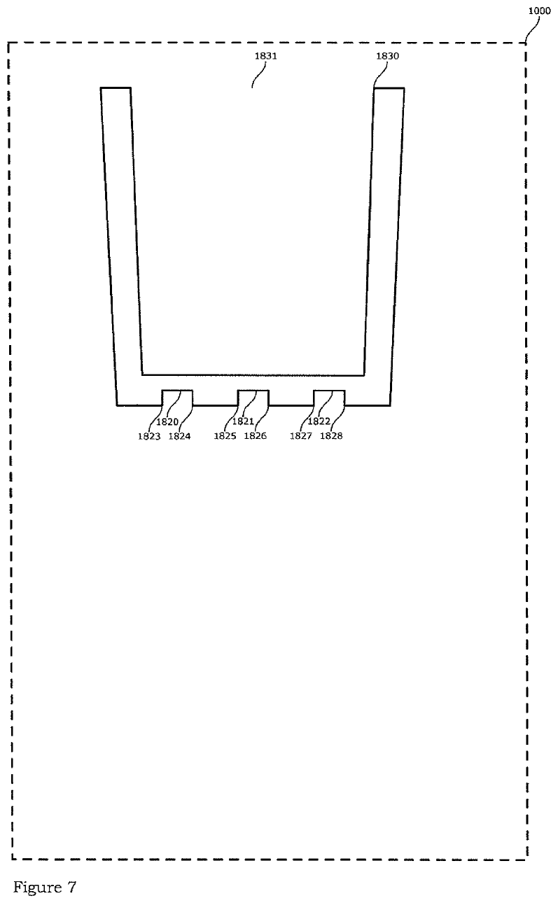

FIG. 7 illustrates an alternative implementation of a container used with the ovitrap 1000. A container 1830 has an opening 1831 on its top. The inner part of the container 1830 is shaped so that it can hold a liquid like water for a predefined period of time. The opening 1831 on top of the container 1830 is shaped so that insects of the targeted species get access to the side walls of the container 1830 and to the surface of the liquid stored in it. A groove 1820 is placed on the outer side of the bottom of the container 1830. The groove 1820 can stretch from one side of the container 1830 to its other side or stretch only partly from one side of the container 1830 to the other side. The groove 1821 can stretch from one side of the container 1830 to its other side or stretch only partly from one side of the container 1830 to the other side. The groove 1822 can stretch from one side of the container 1830 to its other side or stretch only partly from one side of the container 1830 to the other side. Any number of grooves can be used on the outer side of the bottom of container 1830. One set of grooves can stretch from left to right of the container 1830, another set of grooves can stretch from front to back of the container 1830. The groove 1820 has a corner 1823 near the bottom of the container 1830. The groove 1820 has a corner 1824 near the bottom of the container. The groove 1821 has a corner 1825 near the bottom of the container 1830. The groove 1821 has a corner 1826 near the bottom of the container 1830. The groove 1822 has a corner 1827 near the bottom of the container 1830. The groove 1822 has a corner 1828 near the bottom of the container 1830.

It is preferable that the distance between the corner 1823 and the corner 1824 is the same as the distance between the corner 1825 and the corner 1826. It is preferable that the distance between the corner 1823 and the corner 1824 is the same as the distance between the corner 1827 and the corner 1828. Varying the distance between the corners 1823 and 1824 can be used for coding. Varying the distance between corners 1825 and 1826 can be used for coding. Varying the distance between the corners 1827 and 1828 can be used for coding.

The shape of the container 1830 when seen from top can be either round or it can have corners.

A Frame for Holding an Ovitrap

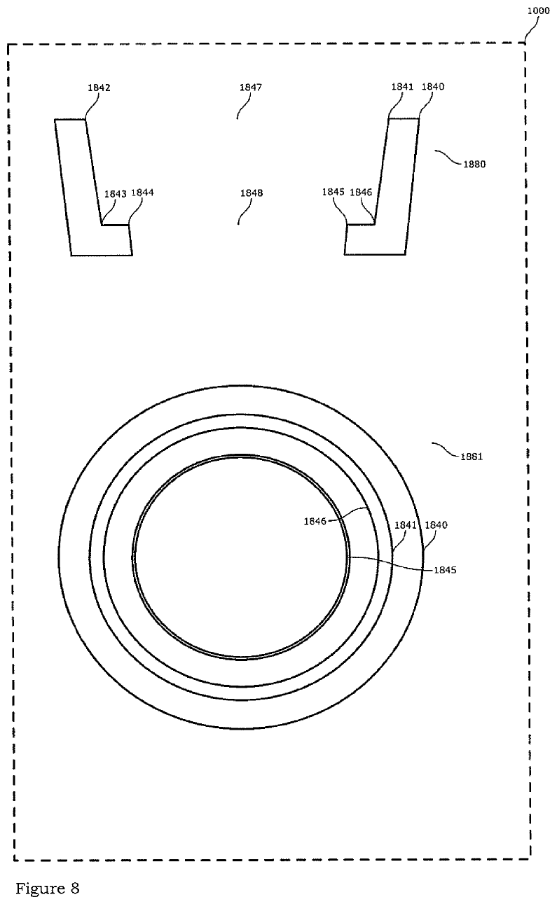

FIG. 8 illustrates an alternative implementation of a frame for use with a container to provide the ovitrap 1000 of FIG. 3. A frame 1840 is shaped so that the distance between an inner corner 1841 and an inner corner 1842 is larger than the distance between an inner corner 1843 and an inner corner 1846. The inner corner 1841 is above the inner corner 1846. The inner corner 1842 is above the inner corner 1843. The inner surface of the frame 1840 between the inner corner 1842 and the inner corner 1843 is even. The inner surface of the frame 1840 between the corner 1841 and the inner corner 1846 is even. The space between the inner corner 1841 and the inner corner 1842 form the opening 1847. The frame 1840 has a small step inwards starting at the inner corner 1843 and ending at the inner corner 1844. The frame 1840 has a small step inwards starting at the inner corner 1846 and ending at the inner corner 1844. The space between the inner corner 1844 and the inner corner 1845 form the opening 1848. The distance between the inner corner 1843 and the inner corner 1846 is larger than the distance between the inner corner 1844 and the inner corner 1845.

The shape of the frame 1840 when seen from top has to have the same shape as the container it is supposed to hold. Especially when a coconut is used as the container 1800 to be held by the frame 1840, it is recommended to use a round shape. Any other shape can be used as long as both the frame 1840 and the coconut's bottom part fit together.

The distance between the corners 1842 and 1843 is equal or less than the distance between the corners 1811 and 1813. The distance between the corners 1841 and 1846 is equal or less than the distance between the corners 1812 and 1814. In other words, the inside of the frame 1840 is shaped so that the container 1800 can be inserted so that the groove 1810 will stay above the frame's 1840 side walls even when the bottom of the container 1800 reaches the bottom of the frame 1840. The side walls of the frame 1840 will hold the container 1810 into position.

Use of a container with the frame of FIG. 8.

The container 1800 is inserted into the opening 1847 so that it sits on the surface provided by the connection of the inner corner 1843 and the inner corner 1844 on one side and the connection of the inner corner 1845 and the inner corner 1846. The distance between the inner corner 1842 and the inner corner 1843 is adjusted so that it is smaller than the distance between the corner 1811 and the corner 1813 of the container 1800. The distance between the inner corner 1841 and the inner corner 1846 is adjusted so that it is smaller than the distance between the corner 1812 and the corner 1814 of the container 1800. Distance between the inner corner 1842 and the inner corner 1841 is larger then the distance between the corner 1811 and the corner 1812. The distance between the inner corner 1843 and the inner corner 1846 is larger then the distance between the corner 1813 and the corner 1814. The distance between the inner corner 1844 and the inner corner 1845 is smaller than the distance between the corner 1813 and the corner 1814.

The dimensions of both the frame 1840 and the container 1800 have to be adjusted so that the container 1800 can be easily inserted from top via the opening 1847 into the frame 1840 without falling out through the opening at the bottom of the frame 1840.

The frame 1840 can be used instead of frame 1700 as described in FIG. 3. The container 1701 is then replace with the container 1800. This implies that the frame 1840 will have the same equipment installed as the frame 1700. The frame 1840 can also be used stand-alone.

A view 1880 shows the frame 1840 as a section. A view 1881 shows the frame 1840 from top. The view 1881 shows the frame 1840 as a round frame. The frame 1840 can also be implemented as a rectangle or as a square when seen like in the view 1881.

The frame 1840 can be combined with the ID sensor 1710, the ovitrap manager 1721, the interface manager 1720, the interface manager 1722, the presence sensor 1711, the weight sensor 1712, the leakage sensor 1713, the dosing unit 1716, the vision sensor 1714 and the larvae sensor 1715.

Base for Use with the Container of FIG. 7

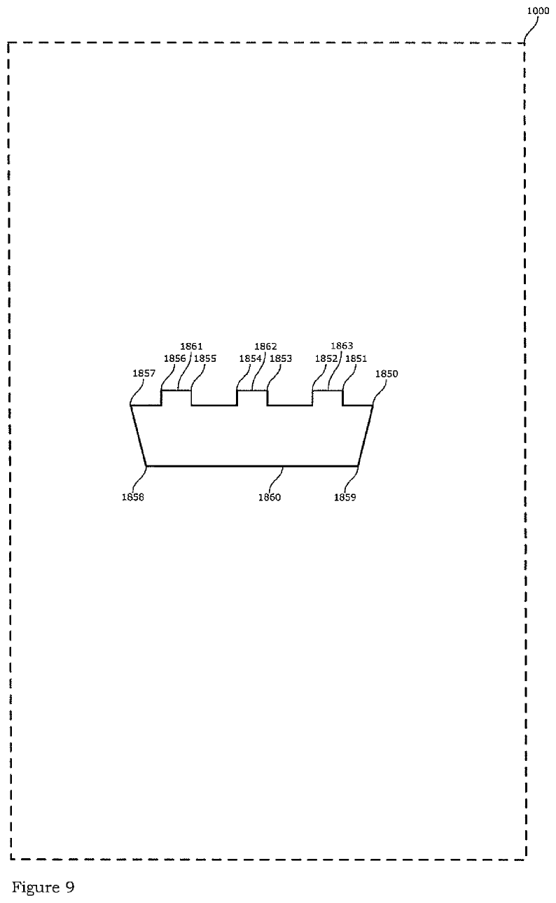

FIG. 9 illustrates a base (or socket) used by the ovitrap 1000 of FIG. 7. The socket 1860 is shaped so that the distance between a corner 1850 and a corner 1857 is larger than the distance between a corner 1858 and a corner 1859. The surface on top of the socket 1860 between the corners 1850 and 1857 has a track 1861. The surface on top of the socket 1860 between the corners 1850 and 1857 has a track 1862. The surface on top of the socket 1860 between the corners 1850 and 1857 has a track. The tracks 1861, 1862 and 1863 are sized so that the container 1830 with its grooves 1820, 1821 and 1822 can be set onto the socket 1860 so that the track 1861 fills the groove 1820 and the track 1862 fills the groove 1821 and the track 1863 fills the groove 1822. At least one groove and one groove have to be present.

The shape of the socket 1860 can be a circle or it can have corners. The size of the socket 1860 has to adjust to the size of the container 1830. When coconuts are used as containers, it is recommended to use sockets of at the least the diameter of a coconut.

The socket 1860 can be used instead of frame 1700 as described in FIG. 3. The container 1701 is then replace with the container 1830. This implies that the socket 1860 will have the same equipment installed as the frame 1700. The socket 1860 can also be used stand-alone.

The socket 1860 can be combined with the ID sensor 1710, the ovitrap manager 1721, the interface manager 1720, the interface manager 1722, the presence sensor 1711, the weight sensor 1712, the leakage sensor 1713, the dosing unit 1716, the vision sensor 1714 and the larvae sensor 1715.

Holding Tool for Use with a Container with a Groove

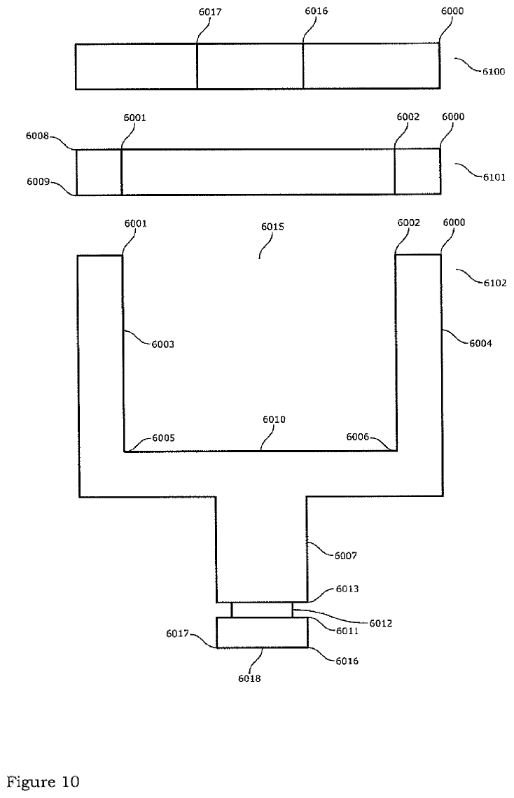

FIG. 10 illustrates a holding tool 6000. A view 6100 shows the holding tool 6100 from its back. A view 6101 shows the holding tool 6000 from its front. A view 6102 shows the holding tool 6000 from its top. The holding tool 6000 can be used by a machine tasked to lift the container 1800. The view 6100 illustrates the holding tool 6000 when seen from its back. The view 6101 illustrates the holding tool 6000 when seen from its front. The view 6102 illustrates the holding tool 6000 when seen from its top. The holding tool 6000 is shaped so that it can be manufacturing by stamping it out of e.g. a flat sheet of metal. The holding tool 6000 can alternatively cut out of a flat piece of wood. The holding tool 6000 can be manufactured using fibre reinforced plastics like polyester. The holding tool 6000 has a holding arm 6003 and a holding arm 6004. The holding arm 6003 and the holding arm 6004 are connected with a beam 6010. The side of the holding arms 6003 and 6004 not connected with the beam 6010 form an opening 6015. The holding arm 6003 has a corner 6001 on its tip opposite of the holding arm 6004. The holding arm 6004 has a corner 6002 opposite the holding arm 6003. The distance between the corner 6001 and the corner 6003 defines the dimension of the opening 6015. The holding arm 6003 and the beam 6010 form an inner corner 6005. The holding arm 6004 and the beam 6010 form the inner corner 6006. The distance between the inner corner 6005 and the inner corner 6006 can be smaller than the distance between the corner 6001 and the corner 6002 but it has to be considered that the container 1800 has to move into the opening 6015 deep enough so that the container 1800 will not leave the holding tool 6000 when the holding tool 6000 is being moved. When the container 1800 is placed on a floor or on its socket, the holding tool 6000 should be able to move out of the groove 1810 without moving the container 1800 when the holding tool 6000 is moved so that the beam 6010 moves away from the container 1800. The holding arm 6003 and the beam 6010 form a L-shaped structure when seen from top. The holding arm 6004 and the beam 6010 form a mirrored L-shaped structure when seen from top. All together, the holding arm 6003, the holding arm 6004 and the beam 6010 form a U-shaped structure when seen from top. The beam 6010 connects to a handle 6007 on the other side of the holding arms 6003 and 6004. The holding tool 6000 can be attached to a machine via the handle 6007. The handle 6007 has a corner 6016 on one side of its end 6018 away from the beam 6010. The handle 6007 has a corner 6017 on the other side of its end 6018. A groove 6012 is located near to the end 6016 of the handle 6007 away from the beam 6010. The groove has a corner 6011 closer to the end 6016 and a groove 6013 farther away from the end 6016. The groove 6012 can be used by a machine to hold the holding tool 6000 while applying forces to all directions. The view 6001 shows the holding tool 6000 when seen from its front. The corners 6001 and 6002 are shown for reference in the middle figure. When seen from its front, the holding tool 6000 has a corner 6008 on its top left side. When seen from its front, the holding tool 6000 has a corner 6009 on the bottom left side. The distance between the corner 6008 and the corner 6009 has to be adjusted so that the holding tool 6000 can be inserted into the groove 1810 of the container 1800 from the side of the container 1800. The corners 6016 and 6017 are shown for reference in the view 6100. The handle 6007 when seen from the back has a rectangle like shape. Alternatively, any other shape can be used which makes sure that the handle will not rotate when forces are applied to the holding tool 6000 while it is held by a machine. This shape allows the machine to pick the tool 6000 up easily and it will make sure that the holding tool 6000 will not rotate itself when held by the machine. The holding arms 6003 and 6004 can be attached so to the beam 6010 that the machine using the holding tool 6000 is able to change the dimension of the opening 6015 while operating the holding tool 6000. The dynamic adjustment of the dimension of the opening 6015 allows the machine operating the holding tool 6000 to adjust the dimension of the opening 6015 to the size of the container 1800. The arm 6010 can connect the holding arm 6003 with the holding arm 6004 in a straight line or in a curved line. Preferable, the contour of line connecting the inner corner 6005 with the inner corner 6006 follows the contour of the container 1800 when seen from the top. Alternatively, a set of holding tools can be provided with different holding tools 6000 have a different distance between the corner 6001 and the corner 6002.

A User Device for Use with the System

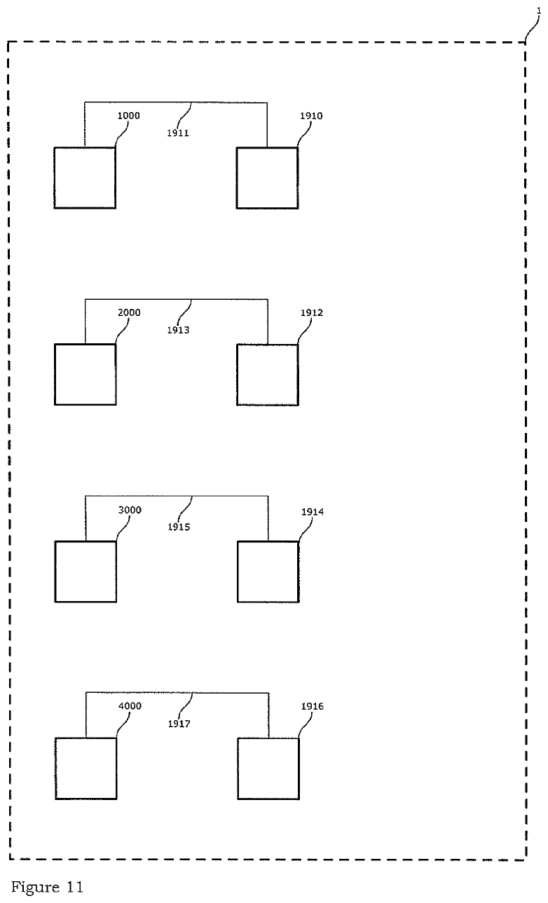

FIG. 11 illustrates the interface for human users of the autonomous mosquito control system 1. A computing device 1910 is connected to the ovitrap 1000 via a connection 1911. A computing device 1912 is connected with the ovitrap handler 2000 via a connection 1913. A computing device 1914 is connected via a connection 1915 with the local manager 3000. A computing device 1916 is connected via a connection 1917 with the global manager 4000.

The connections used in this document can be of any type. Device to device connections with using connection types like 20 mA or RS232 or optical fibre but also network based connection types like Ethernet. Wireless connection with e.g. radio waves are an alternative too. Several elements of the autonomous mosquito control system 1 can be connected via a network like infrastructure.

The computing device 1910 gets access to the internal information of the ovitrap 1000 via the connection 1911. The computing device 1910 can be enabled to alter the internal data of the ovitrap 1000. The computing device 1910 can be enabled to access also the information provided by the assigned ovitrap handler 2000.

The computing device 1912 gets access to the internal information of the ovitrap handler 2000 via the connection 1913. The computing device 1912 can be enabled to alter the internal data of the ovitrap handler 2000. The computing device 1912 can be enabled to access also the information provided by the assigned local manager 3000.

The computing device 1914 gets access to the internal information of the local manager 3000 via the connection 1915. The computing device 1914 can be enabled to alter the internal data of the local manager 3000. The computing device 1914 can be enabled to access also the information provided by the assigned global manager 4000.

The computing device 1916 gets access to the internal information the global manager 4000 via the connection 1917. The computing device 1916 can be enabled to alter the internal data of the global manager 4000.

The computing devices 1910, 1912, 1914 or 1916 can be equipped with an interface to interact with a human. The human operating a computing device 1910, 1912, 1914 or 1916 can be authorised to access and/or alter individual information provided by any of the ovitrap 1000, ovitrap handler 2000, local manager 3000 or global manager 4000.

Status information provided by the ovitrap 1000 includes but is not limited to a unique ID, water level information, visual image of the content of the ovitrap 1000, a signal set when larvae was detected inside the ovitrap, a signal set when pupae was detected inside the ovitrap, the weight of the ovitrap, the presence status of the ovitrap, the schedule of past activities including but not limited to emptying, drying, refilling and collecting. Emptying refers to the purging of the liquid contained inside the container 1100. Drying refers to keeping the container 1100 empty so that it can dry. Refilling refers to moving the liquid into the container 1100 with or without attractant. Ovitraps can provide additional information like the time when the ovitrap was placed at the current location, when the ovitrap was checked the last time, their current weight and if leakage is detected. An event log can be kept and read with the status information. The ovitrap pictured in FIG. 2 will also provide the status of the control element 1300 and the control element 1301.

The ovitrap 1000 will send notifications via the connection to the computing device 1910. When this notification is not honoured by the computing device 1910 within a predefined period of time, the ovitrap 1000 sends this notification to the computing device 1912 via the ovitrap handler 2000. When this notification is not honoured by the computing device 1912 with a predefined period of time, this notification will be send to the computing device 1914 via the local manager 3000. When this notification is not honoured by the computing device 1914, this notification will be send to the computing device 1916 via the global manager 4000.

All notifications send out by the ovitrap 1000 will be classified. All notifications send out by the ovitrap handler 2000 will be classified. All notifications send out by the local manager 3000 will be classified. All notifications send out by the global manager 4000 will be classified. If a notification is classified as a status report, no further action will be taken. If a notification is classified as essential other functional elements—like ovitraps 1000, 1001 or 1002; ovitrap handlers 2000, 2001 or 2002; local managers 3000, 3001 or 3002—of the autonomous mosquito control system 1 will be notified of the event. If a notification is classified as fatal, the source of the notification will be deactivated and human intervention will be requested.

A human operator can enter reports of insect sightings from areas covered by the autonomous mosquito control system 1 and from areas not covered by the autonomous mosquito control system 1 into any of the computing devices 1910, 1912, 1914 or 1916. A human operator can extract reports in regard of mosquito sightings from any of the computing devices 1910, 1912, 1914 or 1916.

Any of the computing devices 1910, 1912, 1914 or 1916 collects information from human operators and other data sources regarding disease outbreaks vectored by the insects specie or species targeted by the autonomous mosquito control system 1.

Any of the computing devices 1910, 1912, 1914 or 1916 collects information from human operators and other data sources of insect sightings for species targeted by the autonomous mosquito control system 1.

The autonomous mosquito control system 1 selects and configures the ovitrap 1000 which targets the reported insect species most efficiently.

The global managers 4000, 4001 and 4002 collect all geographical information from all ovitraps 1000, 1001 and 1002, ovitrap handlers 2000, 2001 and 2002 and local managers 3000, 3001 and 3002 to create a map of the protected areas. The map of the protected areas will be linked with the reports regarding insect sightings and disease outbreaks inside and outside the protected area. The map will contain all current and previous positions of the ovitraps 1000, 1001 and 1002. The positions of the ovitraps 1000, 1001 and 1002 mapped will be linked with the history of insect sightings and their positions. The map of the protected areas will contain over time the development of the insect populations and the diseases vectored by the insects. The global managers 4000, 4001 and 4002 will monitor the development of the insect populations inside the protected areas and activate ovitraps 1000, 1001 and 1002 in the affected areas to eliminate the insect populations. The number of active ovitraps 1000, 1001 and 1002 in an affected area will be determined depending on the availability of ovitraps 1000, 1001 and 1002 and the number of insects sighted in an affected area, for example as determined by the sensors on the ovitraps. With the decimation of the insect populations, the global managers 4000, 4001 and 4002 will reduce the number of active ovitraps 1000, 1001 and 1002 in the affected areas. The number of active ovitraps 1000, 1001 and 1002 inside a protected area without reports of insect sightings and diseases will be reduced to zero by the global managers 4000, 4001 and 4002. The number of active ovitraps 1000, 1001 and 1002 on the perimeter of a protected area without reports of insect sightings will be reduced but a minimal number of ovitraps 1000, 1001 and 1002 will be kept active to protect the protected area from invading insects.

The global managers 4000, 4001 and 4002 will adjust the number of active ovitraps 1000, 1001 and 1002 in a protected area dynamically steered by the reported number of insects and the number of larvae detected in the ovitraps 1000, 1001 and 1002.

The global managers 4000, 4001 and 4002 generate out of the map of the protected areas individual maps containing each only the locations free of targeted insects species, locations with active ovitraps 1000, 1001 and 1002 but no reports of insect sightings, locations with active ovitraps 1000, 1001 and 1002 with reports of insect sightings, locations reports with insect sightings but no active ovitraps 1000, 1001 or 1002, locations without any reports of diseases linked to the targeted insect species, locations with reports if individual diseases linked to the targeted insect species and locations with reports of two or more diseases linked to the targeted insect species.

The maps generated by the global manager 4000, 4001 and 4002 can be send to the computing devices 1910, 1912, 1914 and 1916. The maps are provided for decision making processes for which the presence of certain insects and their vectored diseases are an important factor.

A Further Permanent Ovitrap

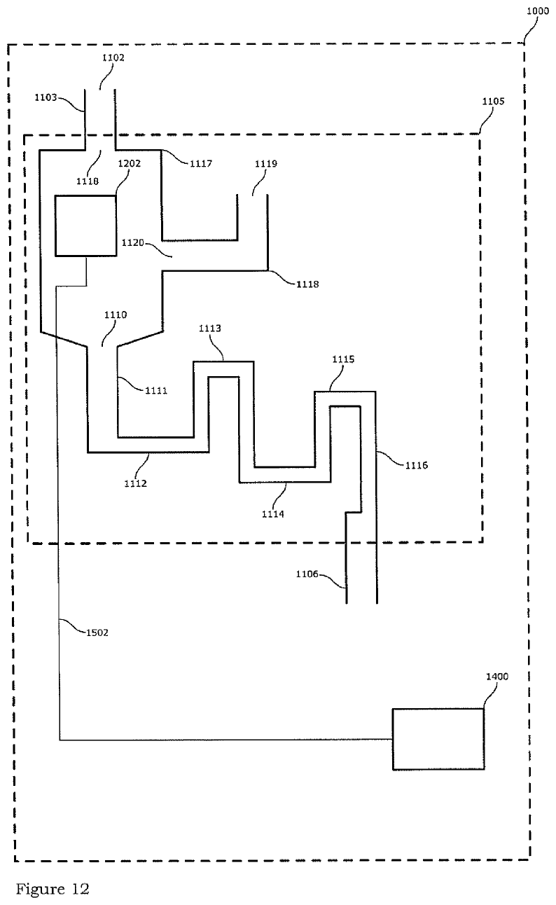

FIG. 12 illustrates a permanent ovitrap including a chamber 1105 used together with the container 1100 as shown in FIG. 2. The opening 1102, the pipe 1103, the level sensor 1202, the pipe 1106, the connection 1502 and the ovitrap manager 1400 are already contained in the description of FIG. 2.

A compartment 1117 is contained inside the chamber 1105. The level sensor 1202 is located inside the compartment 1117 at a predefined level. The compartment 1117 has an opening 1118. The opening 1118 is connected to the pipe 1103. The opening 1118 is arranged so that liquid leaving the container 1100 via the opening 1102 can enter the compartment 1117 only by gravity. The compartment 1117 has an opening 1110. The opening 1110 is arranged so that liquid entering the compartment 1117 via the opening 1118 can leave the compartment 1117 only by gravity. The compartment 1117 has to be designed so that it can contain a liquid over a longer period of time at a low pressure. The compartment 1117 has to be designed so that particles entering the compartment via the opening 1118 are able to leave the compartment via the opening 1110. The compartment 1117 is connected to a pipe 1111. The pipe 1111 has at least five sections. A section 1112 of the pipe is arranged lower than the opening 1110. A section 1113 is arranged so that it is located at a higher level than the section 1112 but lower than the opening 1110. A section 1114 is arranged to that it is located at a lower level than the section 1112. A section 1115 is arranged so that it is located lower than the section 1113 but higher as the section 1112 and the section 1114. A section 1116 is arranged so that the liquid arriving from the section 1115 of the pipe 1111 can flow downwards into the pipe 1106. In other words, the liquid arriving from the compartment 1117 at the pipe 1111 will flow first down, then a predefined distance horizontal in section 1112, then upwards into the section 1113 where the liquid will flow a predefined distance horizontal again before it flows down into the section 1114 where it will flow a predefined distance horizontal again before it flows up into the section 1115 where it flows a predefined distance in section 1115 horizontal again before flowing via section 1116 down into the pipe 1106. The function of the sections 1112, 1113, 1114, 1115 and 1116 is to trap developed larvae, pupae and adult mosquitoes so that they are not able to leave the ovitrap 1000 when the container 1100 is empty. A pipe 1118 is connected to the compartment 1117 so that the connection between the compartment 1117 and the pipe 1118 create an opening 1120 below the position of the level sensor 1202. The pipe 1118 has a second opening 1119 positioned so that it is above the top of the container 1100. When the container 1100 is filled, the liquid level in the pipe 1118 will correspond with the liquid level inside the container 1100. When the liquid flow through the pipe 1103 is blocked for some reason and the control element 1300 allows the liquid to flow out of the container 1100, air will enter the compartment 1117 via the pipe 1118. Finally, the level sensor 1202 will signal a liquid level below its position to the ovitrap manager 1400 while the level sensor 1201 will still signal that the liquid level inside the container 1100 is above its position. This is an error condition most like caused by some kind of blockage in the path the liquid is supposed to take. The ovitrap manager 1400 will notify the ovitrap handler 2000 of the error condition in the ovitrap 1000.

Ovitrap Handler

FIG. 13 illustrates an ovitrap handler 2000 in greater detail. As described above, the ovitrap handler may be in the form of an autonomous vehicle service station.

A section manager 2110 is connected via a connection 2710 with an interface manager 2100. The section manager 2110 is connected via a connection 2711 with an interface manager 2101. The section manager 2110 is connected via a connection 2712 with an interface manager 2102. The section manager 2110 is connected via a connection 2713 with an interface manager 2103. The section manager 2110 is connected via a connection 2723 with a vehicle refuelling unit 2118. The section manager 2110 is connected via a connection 2722 with a vehicle parking system 2118. The section manager 2110 is connected via a connection 2721 with an ovitrap disposal unit 2115. The section manager 2110 is connected via a connection 2720 with an ovitrap cleaning unit 2116. The section manager 2110 is connected via a connection 2719 with an ovitrap dispenser 2114. The section manager 2110 is connected via a connection 2718 with a ovitrap store 2113. The section manager 2110 is connected via a connection 2716 with a ovitrap shaping unit 2112. The section manager 2110 is connected via a connection 2715 with a raw material store 2111. The section manager 2110 is connected via a connection 2714 with an ovitrap receiver 2119. The ovitrap receiver 2119 receives ready made containers 1800 to be used as ovitraps via a connection 2741 to an ovitrap supply. The ovitrap cleaning unit 2116 is connected with a connection 2724 with the ovitrap store 2113. The section manager 2110 is connected via a connection 2725 with a vehicle cleaning unit 2120. The section manager 2110 is connected via a connection 2722 with a vehicle parting unit 2117. The section manager 2110 is connected via a connection 2826 with a vehicle refilling unit 2121.

The raw material store 2111 has a connection 2740 to a raw material supply. The raw material supply supplies the raw material required by the ovitrap shaping unit 2112 to make the containers 1800 as required for the use by the ovitrap 1000. The raw material can be coconuts either fresh from a tree, coconuts not fit for human consumption or opened coconuts with the liquid and the meat already removed. The raw material is stored in the raw material store 2111. On request of the section manager 2110—send via the connection 2715—the raw material is moved via the connection 2739 to the ovitrap shaping unit 2112.

The ovitrap shaping unit 2112 shapes ovitraps on commands send via the connection 2716 by the section manager 2110. Any biodegradable material can be used which is able to hold water for a predefined period of time. Coconuts present an ideal raw material but materials like wood can also be used for this purpose. For coconuts as the raw material, the following steps will be carried out by the ovitrap shaping unit 2112. The ovitrap shaping unit 2112 classifies the arriving coconuts into three categories: fresh coconuts, used coconuts—be as a drink at a bar of just the meat and liquid being removed for cooking—and unfit coconut. The unfit coconuts are disposed. The fresh coconuts are oriented to that the side of the stem is on top of the coconut. The top of the coconut is then cut off until an opening between 20 mm and 100 mm appears. In the next step the coconuts with the top cut off are processed the same way as the used coconuts. The liquid and the meat are then removed from the inside of the coconut. The coconuts are then orientated so that the opening is on a predefined position preferable on top. The ovitrap shaping unit 2112 gives the coconut the shape as required to be used as the container 1800 by cutting surplus material away. As a natural product, the coconuts come in different sizes and shapes. As such, the ovitrap shaving unit 2112 will shape the coconuts according to the requirements of the container 1800 but with dimensions best matching the dimension of the coconut. The coconuts will be finally classified into different sizes and—when not possible—be disposed. The coconuts fulfilling the requirements of the system to be used as the container 1800 will then be handed over to the ovitrap store 2113 via the connection 2732.

The ovitrap receiver 2119 supplies containers 1800 via the connection 2718 to the ovitrap store 2113. The containers 1800 are supplied by the ovitrap receiver 2119 on a request send by the section manager 2110 via the connection 2714 to the ovitrap receiver 2119.

The ovitrap store 2113 keeps a number of containers 1800 ready for use in its storage area. The containers 1800 are stored according to their size as supplied via the connections 2731 and 2717. On request of the section manager 2110 send via the connection 2718 the containers 1800 are moved via the connection 2732 to the ovitrap dispenser 2114. The ovitrap dispenser 2114 supplies then the containers 1800 via the connection 2742 to the consumer. Alternatively, the ovitrap dispenser 2114 will dispense containers 1800 filled with the liquid used to attract the targeted insects.

The ovitrap disposal unit 2115 receives containers 1800 which have been used by an ovitrap 1000 via a connection 2743 from a consumer. The container 1800 can be filled with water, insect eggs, larvae and pupae and any other objects fallen into the container 1800 while being used as an ovitrap. The ovitrap disposal unit 2115 collects the received containers 1800 and sends them over to the ovitrap cleaning unit 2116 on request of the section manager 2110 send over via the connection 2721.

The ovitrap cleaning unit 2116 removes the liquid from the containers 1800 received via the connection 2733 so that the insect eggs, larvae and pupae are not able to develop into adult insects and escape. Ideally, the liquid contained in the containers 1800 is moved underground. Any solids arriving with the container 1800 are separated and disposed. It has to be made sure that insect eggs, larvae and pupae attached to the solids will not be able to develop into adult insects and escape. This can be achieved by exposing the solids to sun and keep them dry for a period of time or cover them with other solids like soil. The container 1800 is then washed with water. The clean container 1800 is then moved to the ovitrap store 2113 via the connection 2724.

Any vehicles not in use will return to the vehicle parking unit 2117. The section manager 2110 is updated via the connection 2722 over the number and type of vehicles available in the parking unit 2117.

Any vehicle, especially vehicles with a built-in ovitrap, will be instructed by the section manager 2110 to move to the vehicle cleaning unit 2120 when cleaning of the vehicle and/or cleaning of the built-in ovitrap is required.

Any vehicle will be instructed by the section manager 2110 to move to the vehicle refuelling unit 2118 when the vehicle runs low on fuel or when the section manager 2110 expects that the vehicle will run low on fuel during its coming mission.

Any vehicle, especially vehicles with a built-in ovitrap, will be instructed by the section manager 2110 to move to the vehicle refilling unit 2121 to get their container refilled.

The interface manager 2100 has a connection 2700. The interface manager 2100 connects via the connection 2700 with the assigned ovitraps. The interface manager 2101 has a connection 2701. The interface manager 2101 connects via the connection 2701 with the ovitrap handlers. The interface manager 2102 has a connection 2702. The interface manager 2102 connects via the connection 2702 with the local managers. The interface manager 2103 has a connection 2703. The interface manager 2103 connects via the connection 2703 with the assigned vehicles.

The section manager 2110 exchanges data including commands and status reports via the interface managers 2100, 2101, 2102 and 2103 with the connected ovitraps 1000, ovitrap handlers 2000, local managers 3000 and the vehicles.

Autonomous Vehicle with an Integral Ovitrap

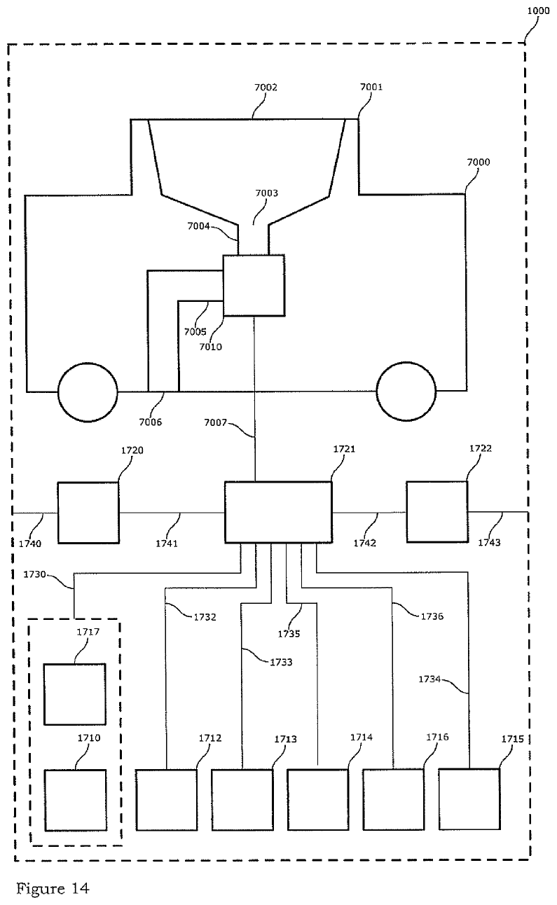

FIG. 14 illustrates a vehicle 7000 in which a container 7001 is integrated so that insects can enter the container 7001 from its top via an opening 7002 and access its side walls and the surface of the liquid stored inside the container 7001 so that they can deposit their eggs there. The vehicle 7000 works as an ovitrap 1000 for the autonomous mosquito control system 1. The vehicle 7000 is able to navigate autonomously in a predefined area. The container 7001 has an opening at the lowest point of its bottom located so that all the liquid contained in the container 7001 can leave the container 7001 only by the use of gravity. The opening 7003 is connected to a pipe 7004. The pipe 7004 is connected to a control element 7010. The control element 7010 is connected to a pipe 7005. The pipe 7005 has an opening 7006 on its other end. The opening 7003, the pipe 7004, the control element 7010, the pipe 7005 and the opening 7006 are arranged so that all the liquid contained in the container 7001 is able to leave the container 7001 when the control element 7010 is activated. Alternatively, the vehicle 7000 can be turned upside down and kept in this position until all of the liquid previously stored in the container 7001 and all other object have left the container 7001. The autonomous vehicle 7000 is equipped with the ovitrap manager 1721, the interface manager 1720, the interface manager 1722, the connection 1740, the connection 1741, the connection 1742, the connection 1743, the ID sensor 1710, the ID 1717, the weight sensor 1712, the leakage sensor 1713, the vision sensor 1714, the dosing unit 1716, the larvae sensor 1715, the connection 1730, the connection 1732, the connection 1733, the connection 1734, the connection 1735 and the connection 1736 as describes previously. Differences are that the ID 1717 and the ID sensor 1710 are combined to a single unit as the container 7001 is part of the vehicle and the connections 1740 and 1743 are preferably done without wires. The connections 1740 and 1743 are used to communicate with other elements of the autonomous mosquito control system 1.

The autonomous vehicle 7000 has a map of the area it is supposed to work in stored. The autonomous vehicle 7000 has a map of locations stored where it is safe to deposit the content of the container 7001 in case of emergencies. The locations are classified. Areas in which it is always safe to deposit the content of the container 7001 are classified as always safe. Some areas which are safe but for other reasons like aesthetics are preferably not used for depositing the content of the container 7001 are classified as safe with limitations. Areas which could allow the eggs, larvae and pupae being deposited by the vehicle develop into adult insects are classified as totally unsafe and the vehicle 7000 will never deposit any content of the container 7000 in these areas. More classifications can be used to better fine tune the behaviour of the vehicle 7000 in case of emergencies.

The vehicle 7000 can be build so that it can navigate in water, in air and/or at land.

Normal Operation of the Autonomous Vehicle with Integral Ovitrap

The vehicle 7000 waits at the vehicle parking unit 2117. The container 7001 is empty. The position of the vehicle 7000 is always known by the section manager 2110. The ovitrap manager 1721 reports to the section manager 2110 of the section the vehicle parking unit 2117 belongs to its status. When the section manager 2110 receives the instruction from its local manager 3000 to send the vehicle 7000 out for a mission, the section manager 2110 instructs the vehicle 7000 to start a mission. The instruction to start the mission will include the location where the mission should be executed. It could contain the path to be used to arrive at the location. Alternatively, the path information can be stored together with the map in the vehicle 7000. The vehicle 7000 will move to the vehicle refuelling unit 2118 to get sufficient fuel for the mission plus some extra for emergencies. The vehicle 7000 will then move to the vehicle refilling unit 2121 to get its container 7001 filled with a liquid able to attract the targeted insect species. The vehicle 7000 moves after it is refilled to the location it was instructed. The vehicle 7000 will wait then at the given location as instructed. When the waiting time is over, the vehicle 7000 will move to the vehicle cleaning unit 2120. The vehicle cleaning unit 2120 will receive the liquid and all other items brought back by the vehicle 7000. The vehicle cleaning unit 2120 will dispose the objects received so that no insects will be able to emerge and escape. The vehicle 7000 will then move to the vehicle refuelling unit 2118 to be refuelled fully or partially. The vehicle 7000 will then move to the vehicle parking unit 2117 and report back to the section manager 2110.

While the autonomous vehicle is in its waiting position, the insects living near the waiting position will detect the opportunity to deposit their eggs into the container 7001. The eggs deposited together with the larvae and pupae which might have developed during the waiting time, will then be moved to the vehicle cleaning unit 2120 when the autonomous vehicle 7000 returns to it.

Emergencies

The main emergency will be that the vehicle 7000 is not able to return to the vehicle cleaning unit 2120 to deposit the collected eggs, larvae and pupae before adult insects are able to emerge. In any case, the vehicle 7000 will inform the assigned section manager 2110 via its interface manager 1720 and the connection 1740 of the emergency and the status of the vehicle 7000. The vehicle 7000 will in such cases also inform other ovitraps 1000 via the interface manager 1722 and the connection 1743 of the emergency. In all cases, the information send to both the section manager 2110 and the ovitraps 1000 will contain the location of the vehicle 7000. The vehicle 7000 first try to reach a location classified as safe in the stored map. If this is not possible, the vehicle 7000 will try to reach a location with a classification with some limitations. As all locations the vehicle 7000 will be able to reach inside its working area are classified, it will always know if it is able to deposit the content of the container 7000 or simply have to keep it inside as the risk is too high that the deposited eggs, larvae and pupae will develop uncontrolled into adult insects. Human intervention is required in such cases. As the last location of the vehicle 7000 is always known, human intervention is always possible.

The vehicle 7000 can be build so that it can navigate in water, in air and/or at land.

Use within the System of the Autonomous Vehicle with Integrated Ovitrap

The vehicle 7000 main usage will be in case of emergencies when reports arrive at the autonomous mosquito control system 1 that insects which could be targeted by the ovitraps 1000 being part of the autonomous mosquito control system 1 are inside the covered area. One or more vehicles 7000 will be instructed by the global manager 4000, 4001 or 4002 or by the local manager 3000, 3001 or 3002 or by the ovitrap handler 2000, 2001 or 2002 to move to the area defined in the report. The vehicles 7000 will be spread over the affected area so that the targeted insects species have a high chance to deposit their eggs into the container 7001 of the vehicle 7000. When no new reports of targeted insects being present in an area covered by the vehicles 7000 arrive at the autonomous mosquito control system 1, the vehicles 7000 can be moved out of the area previously covered by them.

Usage of the vehicle 7000 under any other condition is possible.

Map

When no map is available for a new operating area, the vehicle 7000 can be used to create the map. To be able to handle emergency situations without a map, one or more vehicles 7000 will swarm out from the vehicle parking unit 2117 after being prepared for the mission, instructed by the section manager 2110 so that the vehicles 7000 move initially into different directions. The vehicles 7000 will try to form a grid with the vehicle parking unit 2117 as the centre. Any other known location can be defined as the centre. The section manager 2110 will coordinate the movements of the vehicles 7000. The section manager 2110 will calculate an ideal grid out of the predefined working area. Different vehicles 7000 will then be instructed to reach the nodes of the predefined working area. Whenever a vehicle 7000 reaches its predefined location, which is a node on the map, it will stop and start collecting eggs. Vehicles 7000 not being able to reach their designated locations will continue searching for a path to the node. The vehicles 7000 will return to the vehicle refuelling unit 2118 when required. The section manager 2110 will collect the position information from the vehicles 7000 and calculate a map of waiting locations for the vehicles 7000 and paths to be used in the future to reach these waiting locations more efficient.

Human intervention is always possible via the computing devices 1910, 1912, 1914 and 1916.

Autonomous Vehicle for Administering an Ovitrap

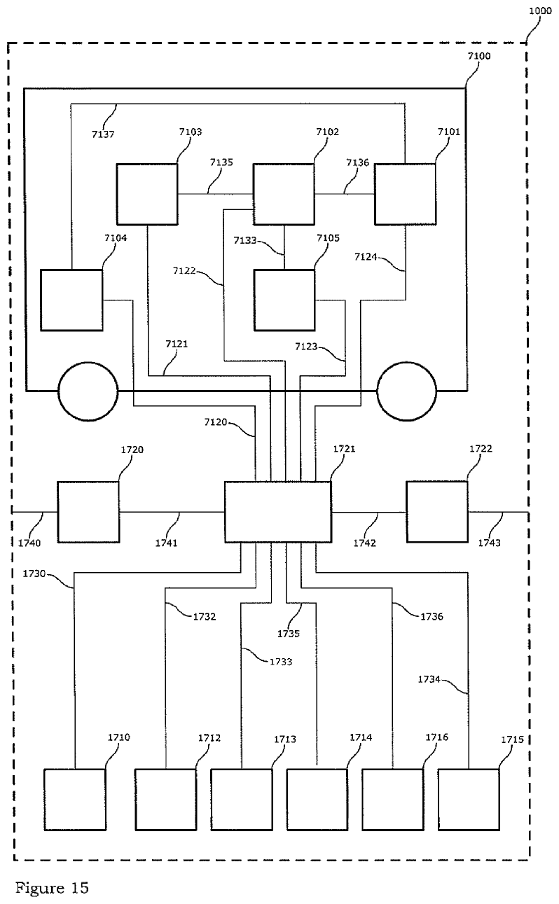

FIG. 15 illustrates a vehicle 7100. The vehicle 7100 is able to navigate autonomously inside a predefined area. The autonomous vehicle 7100 is equipped with the ovitrap manager 1721, the interface manager 1720, the interface manager 1722, the connection 1740, the connection 1741, the connection 1742, the connection 1743, the ID sensor 1710, the ID 1717, the weight sensor 1712, the leakage sensor 1713, the vision sensor 1714, the dosing unit 1716, the larvae sensor 1715, the connection 1730, the connection 1732, the connection 1733, the connection 1734, the connection 1735 and the connection 1736 which function as described previously. Differences are that the connections 1740 and 1743 are preferably done without wires. The connections 1740 and 1743 are used to communicate with other elements of the autonomous mosquito control system 1. The vehicle 7100 is equipped with a fresh container store 7103. The vehicle 7100 is equipped with a container filling unit 7102. The vehicle 7100 is equipped with an ovitrap handler 7101. The vehicle 7100 is equipped with a used container store 7104. The vehicle 7100 is equipped with a liquid tank 7105. The liquid tank 7105 is able to hold the liquid used as an attractant for the container 1800. The ovitrap manager 1721 is connected via a connection 7120 with the used container store 7104. The ovitrap manager 1721 is connected via a connection 7121 with a fresh container store 7103. The ovitrap manager 1721 is connected via a connection 7122 with the container filling unit 7102. The ovitrap manager 1721 is connected via a connection 7123 with the water tank 7105. The ovitrap manager 1721 is connected via a connection 7124 with the ovitrap handler 7101.

The fresh container store 7103 is connected via the connection 7135 with the container filling unit 7102. The container filling unit 7102 is connected via a connection 7136 with the ovitrap handler 7101. The ovitrap handler 7101 is equipped with the tool 6000.

The fresh container store 7103 can be loaded with one or more empty containers 1800. Alternatively, the containers 1800 are already filled with the liquid used to attract insects. The used container store 7104 can be loaded with one or more filled containers 1800. The used container store 7104 has to be designed so that liquid and other objects leaving the container 1800 will not be able to leave the vehicle 7100.

When the ovitrap manager 1721 receives the command to place a container 1800 into a given position from the ovitrap handler 2000, 2001 or 2002, the vehicle 7100 will move autonomously to the given position and place one container 1800 there by executing the following steps. The fresh container store 7101 holds one or more containers 1800. The containers 1800 stored in the fresh container store 7101 are either empty or hold fresh liquid without eggs, larvae of pupae of the targeted insect species. On instruction from the ovitrap manager 1721 send over via the connection 7121, the fresh container store 7103 moves one container 1800 over to the ovitrap filling 7102. The ovitrap filling unit 7102 fills the container 1800 to a predefined level as required. The liquid required for filling the container 1800 is stored in the liquid tank 7105 and moved over to the ovitrap filling unit 7102 via the connection 7133 on command send over from the ovitrap manager 1721 via the connection 7123. The ovitrap filling unit 7102 moves the container 1800 via the connection 7136 over to the ovitrap handler 7101. The ovitrap handler 7101 takes the container with the tool 6000 and then moves the container 1800 into its designated position. The container 1800 can be set directly on an even surface. Alternatively, the frame 1840 can be used to hold the container 1800 into position.

When the ovitrap manager 1721 receives the command to remove one container 1800 from a given position from the ovitrap handler 2000, 2001 or 2002, the vehicle 7100 will move to the given position and take the container 1800 from its position by executing the following steps. The ovitrap handler 7101 takes the container using the tool 6000 from its current position and moves it via the connection 7137 to the used container store 7104.

The autonomous vehicle 7100 has a map of the area it is supposed to work in stored. The autonomous vehicle 7100 has a map of locations stored where it is safe to deposit the content of the container 1800 in case of emergencies. The locations are classified. Areas in which it is always safe to deposit the content of the container 1800 are classified as always safe. Some areas which are safe but for other reasons like aesthetics are classified as safe with limitations. Areas which could allow the eggs, larvae and pupae being deposited by the vehicle develop into adult mosquitoes are classified as totally unsafe and the vehicle 7100 will never deposit any content of the container 7100 in these areas. More classifications can be used to better fine tune the behaviour of the vehicle 7100 in case of emergencies.

The vehicle 7100 can be build so that it can navigate in water, in air and/or at land.

Normal Operation of the Autonomous Vehicle for Administering an Ovitrap

The vehicle 7100 waits at the vehicle parking unit 2117 of the ovitrap handler. The fresh container supply 7103 is empty. The ovitrap manager 1721 reports to the section manager 2110 of the section the vehicle parking unit 2117 belongs to its status. When the section manager 2110 receives the instruction from its local manager 3000 to send the vehicle 7100 out for a mission, the section manager 2110 instructs the vehicle 7100 to start a mission. The instruction to start the mission will include the location where the mission should be executed. It could contain the path to be used to arrive at the location. Alternatively, the path information can be stored together with the map in the vehicle 7100. The vehicle 7100 will move to the vehicle refuelling unit 2118 to get sufficient fuel for the mission plus some extra for emergencies. The vehicle 7100 will then move to the ovitrap dispenser 2114 to load the fresh container store 7103 with the instructed number and type of containers 1800. The vehicle 7100 will then move to the vehicle refilling unit 2121 to get its liquid tank 7105 filled with a liquid able to attract the targeted insect species. The vehicle moves after it is refilled to one or more locations it was instructed to. The vehicle 7100 will remove one container 1800 from each location and store it in the used container store 7104 and place at each location one container 1800 taken from its fresh container store 7103 filled with a liquid able to attracted the targeted insect species. The container 1800 will stay at the location while the vehicle 7100 will move to the next locations until all locations given have been served. When the vehicle 7100 is for the first time at a location without a container 1800 in place it skips the step of collecting the container 1800. If the vehicle 7100 is not able to locate then container 1800 in the given location, the vehicle 7100 sends a notification to the section manager 2110 saying that the container 1800 at the given location is absent. Container 1800 equipped with the ID 1717 can be located by scanning for the response of the ID 1717 with a more sensitive ID sensor 1710. One or more vehicles 7100 equipped with the more sensitive ID sensor 1710 will be send out by the section manager 2121 to start a search for the missing container 1800. Preferable, the search starts at the last known location of the container 1800. When the missing container 1800 is found, it will be picked up by the vehicle 7100 and brought back to the ovitrap disposal unit 2115. If the container 1800 cannot be located by the vehicle 7100 within a predefined time, the section manager 2110 sends a notification out requesting human intervention.

Requests for human intervention will be send to the computing devices 1910, 1912, 1914 and 1916. The requests will first be send to the computing device 1910, 1912, 1914 or 1916 being physically closest to the source of the notification. When a notification is not honoured within a predefined time, the notification will be send to the computing device 1910, 1912, 1914 or 1916 farther away. This will be repeated until either the notification is honoured of the notification arrived at global manager 4000, 4001 or 4002 at its directly connected computer devices 1916. If the notification is not honoured by one or more computer devices 1916, the reason for sending the notification will activate special alarm system at the site from which the notification originated. Human intervention will normally be required in such situations.

The container 1800 will attract insects to deposit their eggs in them.

Emergencies

The main emergency will be that the vehicle 7100 is not able to return to the ovitrap disposal unit 2115 to deposit the containers 1800 stored in the used container store 7104 before the collected eggs, larvae and pupae will develop and before adult insects are able to emerge. In any case, the vehicle 7100 will inform the assigned section manager 2110 via its interface manager 1720 and the connection 1740 of the emergency and the status of the vehicle 7100. The vehicle 7100 will in such cases also inform other ovitraps 1000 via the interface manager 1722 and the connection 1743 of the emergency. In all cases, the information send to both the section manager 2110 and the ovitraps 1000 will contain the location of the vehicle 7100. The vehicle 7100 first try to reach a location classified as safe in the stored map and deposit there the content of the containers 1800 stored in the used container store 7104. If this is not possible, the vehicle 7100 will try to reach a location with a classification with some limitations and deposit the content of the containers 1800 stored in the used container store 7104. As all locations the vehicle 7100 will be able to reach inside its working area are classified, it will always know if it is able to deposit the content of the containers 1800 or simply have to keep it inside as the risk is too high that the insects develop uncontrolled. As the last location of the vehicle 7100 is always known, human intervention is possible.

When the vehicle 7100 is not able to locate an old container 1800, a notification is send to the section manager 2110. The section manager can than ask for human intervention.

In emergency situation when no vehicles 7000 and/or no vehicles 7100 are available, the autonomous mosquito control system will notify human operators via the computing devices 1910, 1912, 1914 and 1916. The human operators are told by the autonomous mosquito control system 1 in which locations a container 1800 has to be picked up and/or in which locations a container 1800 has to be placed filled with the liquid to attract the targeted insect species.

Alternative Autonomous Vehicle for Administering an Ovitrap

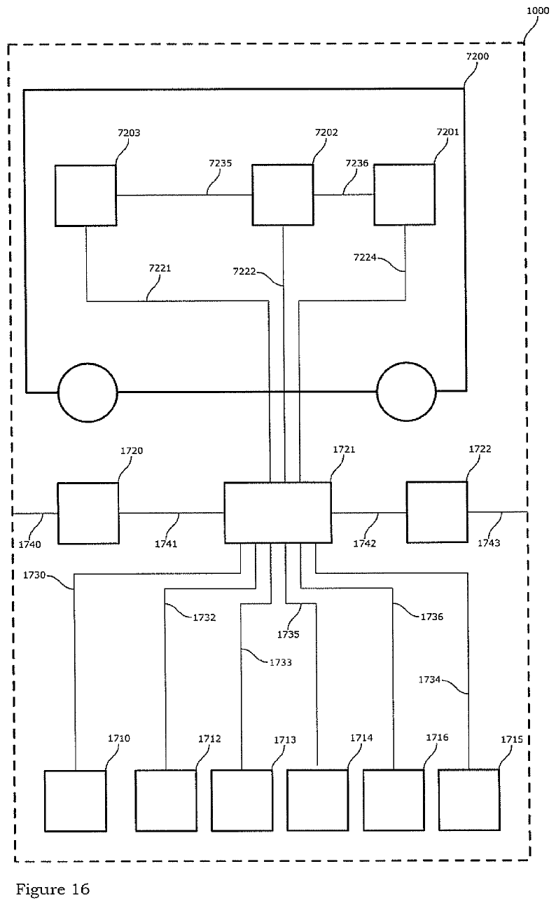

FIG. 16 illustrates a vehicle 7200 similar to that of FIG. 15 but with reduced functionality such that it must return to an ovitrap handler to refill or dispose of containers. The vehicle 7200 is able to navigate autonomously inside a predefined area. The autonomous vehicle 7200 is equipped with the ovitrap manager 1721, the interface manager 1720, the interface manager 1722, the connection 1740, the connection 1741, the connection 1742, the connection 1743, the ID sensor 1710, the ID 1717, the weight sensor 1712, the leakage sensor 1713, the vision sensor 1714, the dosing unit 1716, the larvae sensor 1715, the connection 1730, the connection 1732, the connection 1733, the connection 1734, the connection 1735 and the connection 1736 as describes previously. Differences are that the connections 1740 and 1743 are preferably done without wires. The connections 1740 and 1743 are used to communicate with other elements of the autonomous mosquito control system 1. The vehicle 7200 is equipped with an ovitrap positioning handler 7201. The vehicle 7200 is equipped with a container store 7202. The vehicle 7200 is equipped with an ovitrap collecting handler 7203. The ovitrap manager 1721 is connected via a connection 7222 with the container store 7202. The ovitrap manager 1721 is connected via a connection 7224 with the ovitrap positioning handler 7201. The ovitrap manager 1721 is connected via a connection 7221 with the ovitrap collecting handler 7203. The ovitrap collecting handler 7203 is connected via a connection 7235 with the ovitrap store 7202. The ovitrap store 7202 is connected via a connection 7236 with the ovitrap positioning handler 7201. The ovitrap positioning handler 7201 is equipped with the tool 6000. The ovitrap collecting handler 7203 is equipped with the tool 6000.

The fresh container 7202 can be loaded with one or more filled containers 1800. The container store 7202 has to be designed so that liquid and other objects leaving the container 1800 will not be able to leave the vehicle 7200.

When the ovitrap manager 1721 receives the command to place a container 1800 into a given position from the ovitrap handler 2000, 2001 or 2002, the vehicle 7200 will move autonomously to the given position and place one container 1800 there by executing the following steps. The container store 7202 holds one or more containers 1800. The ovitrap store 7202 moves the container 1800 via the connection 7236 over to the ovitrap positioning handler 7201. The ovitrap positioning handler 7201 takes the container with the tool 6000 and then moves the container 1800 into its designated position. Alternatively, the container 1800 can be placed in the frame 1840.

When the ovitrap manager 1721 receives the command to remove one container 1800 from a given position from the ovitrap handler 2000, 2001 or 2002, the vehicle 7200 will move autonomously to the given position and take the container 1800 from its position by executing the following steps. The ovitrap collecting handler 7203 takes the container from its current position and moves it via the connection 7235 to the container store 7202.

The autonomous vehicle 7200 has a map of the area it is supposed to work in stored. The autonomous vehicle 7200 has a map of locations stored where it is safe to deposit the content of the container 1800 in case of emergencies. The locations are classified. Areas in which it is always safe to deposit the content of the container 1800 are classified as always safe. Some areas which are safe but for other reasons like aesthetics are classified as safe with limitations. Areas which could allow the eggs, larvae and pupae being deposited by the vehicle develop into adult mosquitoes are classified as totally unsafe and the vehicle 7200 will never deposit any content of the container 7200 in these areas. More classifications can be used to better fine tune the behaviour of the vehicle 7200 in case of emergencies.

The vehicle 7200 can be build so that it can navigate in water, in air and/or at land.

Normal Operation of the Alternative Autonomous Vehicle

The vehicle 7200 waits at the vehicle parking unit 2117. The container sup-ply 7202 is empty. The ovitrap manager 1721 reports to the section manager 2110 of the section the vehicle parking unit 2117 belongs to its status. When the section manager 2110 receives the instruction from its local manager 3000 to send the vehicle 7200 out for a mission, the section manager 2110 instructs the vehicle 7200 to start a mission. The instruction to start the mission will include the location where the mission should be executed. It could contain the path to be used to arrive at the location. Alternatively, the path information can be stored together with the map in the vehicle 7200. The vehicle 7200 will move to the vehicle refuelling unit 2118 to get sufficient fuel for the mission plus some extra for emergencies. The vehicle 7200 will then move to the ovitrap dispenser 2114 to load the container store 7202 with the instructed number and type of containers 1800. The containers have to be filled with the liquid to be required to attract the targets insect species. The vehicle moves after it is refilled to one or more locations it was instructed to. The vehicle 7200 will remove one container 1800 from each location and store it in the container store 7202 and place at each location one container 1800 taken from its container store 7202 filled with a liquid able to attracted the targeted insect species. The container 1800 will stay at the location while the vehicle 7200 will move to the next locations until all locations given have been served. The maximum number of locations served in one go has to be adjusted to the storage capacity of the container store 7202 to make sure the containers 1800 collected during a mission are not handed out by mistake. When the vehicle 7200 for the first time at a location without a container 1800 in place it skips the step of collecting the container 1800. If the vehicle 7200 is not able to locate then container 1800 in the given location, the vehicle 7100 sends a notification to the section manager 2110 saying that the container 1800 at the given location is absent. The container 1800 is equipped with the ID 1717. It can therefore be located by scanning for the response of the ID 1717 with a more sensitive ID sensor 1710. One or more vehicles 7200 equipped with the more sensitive ID sensor 1710 will be send out by the section manager 2121 to start a search for the missing container 1800. Preferable, the search starts at the last known location of the container 1800. When the missing container 1800 is found, it will be picked up by the vehicle 7200 and brought back to the ovitrap disposal unit 2115. If the container 1800 cannot be located by the vehicle 7100 within a predefined time, the section manager 2110 sends a notification out requesting human intervention.

Requests for human intervention will be send to the computing devices 1910, 1912, 1914 and 1916. The requests will first be send to the computing device 1910, 1912, 1914 or 1916 being physically closest to the source of the notification. When a notification is not honoured within a predefined time, the notification will be send to the computing device 1910, 1912, 1914 or 1916 farther away. This will be repeated until either the notification is honoured of the notification arrived at global manager 4000, 4001 or 4002 at its directly connected computer devices 1916. If the notification is not honoured by one or more computer devices 1916, the reason for sending the notification will activate special alarm system at the site from which the notification originated. Human intervention will normally be required in such situations.

The container 1800 will attract insects to deposit their eggs in them.

Emergencies

The main emergency will be that the vehicle 7200 is not able to return to the ovitrap disposal unit 2115 to deposit the containers 1800 stored in the used container store 7202 before the collected eggs, larvae and pupae will develop and before adult insects are able to emerge. In any case, the vehicle 7200 will inform the assigned section manager 2110 via its interface manager 1720 and the connection 1740 of the emergency and the status of the vehicle 7200. The vehicle 7200 will in such cases also inform other ovitraps 1000 via the interface manager 1722 and the connection 1743 of the emergency. In all cases, the information send to both the section manager 2110 and the ovitraps 1000 will contain the location of the vehicle 7200. The vehicle 7200 first try to reach a location classified as safe in the stored map and deposit there the content of the containers 1800 stored in the used container store 7202. If this is not possible, the vehicle 7200 will try to reach a location with a classification with some limitations and deposit the content of the containers 1800 stored in the container store 7202. As all locations the vehicle 7200 will be able to reach inside its working area are classified, it will always know if it is able to deposit the content of the containers 1800 or simply have to keep it inside as the risk is too high that the insects develop uncontrolled. As the last location of the vehicle 7200 is always known, human intervention is possible.

When the vehicle 7200 is not able to locate an old container 1800, a notification is send to the section manager 2110. The section manager can than ask for human intervention.

In emergency situation when no vehicles 7000 and/or no vehicles 7100 and/or no vehicle 7200 are available, the autonomous mosquito control system 1 will notify human operators via the computing devices 1910, 1912, 1914 and 1916. The human operators are told by the autonomous mosquito control system 1 in which locations the container 1800 has to be picked up and/or in which locations a container 1800 has to be placed filled with the liquid to attract the targeted insect species.

Usage

The vehicle 7200 can be used the same way as the vehicle 7100 when filled containers 1800 are available at the ovitrap handler 2000, 2001 or 2002 assigned to the vehicle 7200 as the vehicle 7200 is not able to fill the container 1800 with a liquid to attract the targeted insect species. Usage of the vehicle 7200 under any other condition is possible.

Map

The vehicle 7200 can be used just like the vehicle 7100 to create a map of the area it is working in.

General Operation

The autonomous mosquito control system 1 has a hierarchical structure consisting of a number of global managers 4000, 4001 and 4002 on top of the hierarchy. The global managers 4000, 4001 and 4002 have all information regarding the individual ovitraps 1000, 1001 and 1002 available. The global managers 4000, 4001 or 4002 exchange data between each other regarding the individual ovitraps 1000, 1001 and 1002 in use even when the data of an individual ovitrap 1000, 1001 or 1002 reaches only a single global manager 4000, 4001 or 4002. The information the computing devices 1916 are able to access are identical no matter if they access the information via the global manager 4000, 4001 or 4002. The next hierarchy level consists of the local managers 3000, 3001 and 3002. While a fully autonomous mosquito control system 1 is fully operational with a minimum of three global managers 4000, 4001 and 4002, the total number of local managers 3000, 3001 and 3002 is practically not limited. A fault tolerant operation can be achieved at a single location—be if a resort, settlement or city—with a minimum of three local managers 3000, 3001 and 3002. The number of ovitrap handlers 2000, 2001 and 2002 on a single location can be one for normal operation without any fault tolerance or more depending on the level of redundancy required and the capacity required to handle the vehicle 7000 and/or 7100 and/or 7200 at a single location or a section of a location. The number of ovitraps 1000, 1001 and 1002 depends on the level of protection expected and the speed the protection should be achieved plus the targeted insect species. Ovitraps 1000, 1001 or 1002 using the container 1100 are for permanent installations on strategic locations like the perimeter of a property and the points of entry for human and/or goods into a property. A harbour or an airport is the point of entry just as a gate of a housing estate. Alternatively, the automatic lethal ovitrap as described in the patent application PCT SG 2007 000137 can be used in a permanent installation in place of the ovitraps 1000, 1001 and 1002 when equipped with the components as the container 1100. Ovitraps 1000, 1001 and 1002 using the container 1100 can be installed inside a low-density grid of a location to demonstrate easily how insect control is done, demonstrate the availability of insect control at a location and to provide a basic protection when insects randomly invade a location from outside. Insects travelling with vehicles like, boats, vessels, cars, trucks or planes will be able to find breeding spots provided by an ovitrap 1000, 1001 and 1002 near their point of entry to the protected area. Ovitraps 1000, 1001 and 1002 using the container 1800 are used for seasonal requirements to react when the previously insect population returned at random points of a location. The containers 1800 will then be either transported by the vehicles 7100 to the locations determined by the autonomous mosquito control system 1 or by human operators receiving the information regarding the time and location of placement via a computing device 1910, 1912, 1914 and/or 1916. The autonomous mosquito control system 1 will later instruct either the vehicles 7100 and/or 7200 or the human operators via the computing devices 1910, 1912, 1914 and/or 1916 when the previously placed containers 1800 have to be collected again. The cycle of placing containers 1800 as ovitraps 1000, 1001 or 1002 at given locations and removing them again can be executed until the insect population diminished again. The number of containers 1800 and their locations required during each cycle will be determined by the autonomous mosquito control system 1. The vehicle 7000 is the preferred version of the ovitrap 1000, 1001 and 1002 in cases of emergencies. While containers 1800 require at least a flat surface to be placed, the vehicle 7000 requires only a place where it can stop for some time. The vehicle 7000 can change its position while collecting insect eggs. The vehicle 7000 can wait at an ideal position to collect the insect eggs while still being able to move away and return to the ideal position when required. The requirement can arise out of a scheduled use of the area to which the ideal position belongs. The autonomous mosquito control system 1 will then instruct the vehicle 7000 to vacate a position at a given time to return at a later time. The requirement to vacate a position can arise out of local events the sensors of the vehicle 7000 can detect and make the vehicle to vacant the position. When the reason for the move disappears, the vehicle 7000 will return to its original position. The same can be achieved with a combination out of the vehicles 7100 and/or 7200 and the containers 1800 with the limitations given that one vehicle 7100 and/or 7200 removes or returns only a single container 1800 at the same moment of time. Human intervention in combination with the container 1800 is possible but involves the risk that the containers 1800 are misplaced when moved by human operators. The global manager 4000, 4001 and 4002 receive the location, the date of filling, the date of proposed emptying of each ovitrap 1000, 1001 and 1002 used by the autonomous mosquito control system 1 via the ovitrap handlers 2000, 2001 and 2002 and the local managers 2000, 2001 and 2002. The global managers 4000, 4001 and 4002 monitor every ovitrap 1000, 1001 and 1002 in use. When no notifications arrive that an ovitrap 1000, 1001 or 1002 is emptied before adult insects could emerge, notifications are send to all local managers 3000, 3001 or 3002 and ovitrap handlers 2000, 2001 or 2002 linked to the ovitrap 1000, 1001 or 1002 for which no notification was received by the global managers 4000, 4001 or 4002. If after another predefined time still no notification arrives at the global managers 4000, 4001 or 4002, a notification is send to all computing devices 1910, 1912, 1914 or 1916 linked to the ovitrap 1000, 1001 or 1002 for which no notification was received by the global managers 4000, 4001 or 4002 requesting for human intervention at the site the ovitrap 1000, 1001 or 1002 and its ovitrap handler 2000, 2001 or 2002 belongs to. The human intervention can fix the technical problem that blocked the emptying of the ovitrap 1000, 1001 or 1002 or a human operator empties the ovitrap 1000, 1001 or 1002. When reports of insect sightings arrive for a location at one of the global managers 4000, 4001 or 4002 and no ovitraps 1000, 1001 or 1002 are activated in the affected location within a predefined period of time, the global managers 4000, 4001 or 4002 will send notifications to the computing devices 1910, 1912, 1914 and 1916 to ask for human intervention. Human operators will then place containers 1800 as instructed by the global manager 4000, 4001 or 4002 in the affected locations filled with a liquid to attract the targeted insect species. The human operators will notify the global manager 4000, 4001 or 4002 via computing device 1910, 1912, 1914 or 1916 of the placement of an ovitrap together with the location of the ovitrap 1000, 1001 or 1002 and the time of placement. The global manager will then send a notification to the ovitrap handler 2000, 2001 or 2002 via the local manager 3000, 3001 or 3002 assigned to the location the ovitrap 1000, 1001 or 1002 was placed in. The ovitrap 1000, 1001 or 1002 will then be handled by the assigned ovitrap handlers 2000, 2001 or 2002 just like any other container 1800 which is assigned to it. The assigned ovitrap handler 2000, 2001 or 2002 will then use the vehicle 7100 and/or 7200 for further handling of the ovitrap 1000, 1001 or 1002.

1.-54. (canceled)

55. A system for the automated management of a water-breeding insect population, the system comprising:
a plurality of ovitraps, each comprising a container arranged to hold a liquid and collect the eggs of a water-breeding insect, the plurality of ovitraps configured to be distributed over a region in which the population of a water-breeding insect is to be managed;
a plurality of autonomous vehicles;
one or more ovitrap managers configured to communicate with the one or more autonomous vehicles to instruct an autonomous vehicle to perform one or more tasks to administer maintenance of the plurality of ovitraps in the region;
one or more global managers, each global manager connected to each ovitrap manager and connected to every other global manager; wherein
the global managers are configured to send instructions to the ovitrap managers to administer maintenance of the ovitraps via the autonomous vehicles; and wherein each global manager is configured to communicate with every other global manager to send and receive data regarding the status of the ovitraps and ovitrap managers.

56. The system of claim 55, wherein each ovitrap, autonomous vehicle, ovitrap manager and global manager comprises a communications interface configured to send and receive data.

57. The system of claim 55 wherein the container comprises a circumferential groove and the autonomous vehicle comprises a holding tool having a forked shape with two arms arranged to engage with the groove to allow the autonomous vehicle to grip and hold the ovitrap.

58. The system of claim 55 wherein the ovitrap container is removable and each ovitrap further comprises a fixed part configured to hold the removable container in place such that the removable container can be removed and replaced on the fixed part by the autonomous vehicle.

59. The system of claim 58 wherein the removable container comprises a machine-readable ID comprising information about the container;
the fixed part comprises a reader configured to read the machine-readable ID to extract the information about the container; and
the ovitrap comprises a communications interface configured to send the extracted information to the ovitrap manager.

60. The system of any claim 55 further comprising;
an autonomous vehicle service station for use in a system for the automated management of a water-breeding insect population, the autonomous vehicle service station comprising:
an autonomous vehicle refuelling unit configured to refuel an autonomous vehicle;
an ovitrap disposal unit configured to dispose of and/or clean a used ovitrap received from an autonomous vehicle; and
an ovitrap dispenser configured to dispense an ovitrap for collection by an autonomous vehicle.

61. The system of 55 claim further comprising:
a user device connected to one or more of the plurality of ovitraps, autonomous vehicles, ovitrap managers and global managers, wherein the user device is configured to send and receive data.

62. An ovitrap for use with the system of claim 55, the ovitrap comprising:
a fixed part arranged for installation at a fixed location; and
a removable container arranged to be mounted on the fixed part and to hold a liquid and collect the eggs of a water-breeding insect, the removable container comprising a machine-readable ID comprising information about the container; wherein
the fixed part comprises a reader configured to read the machine-readable ID to extract the information about the container and a communications interface configured to transmit data.

63. The ovitrap of claim 62 wherein the fixed part comprises a frame comprising an upper opening arranged to receive the removable container and tapering internal walls arranged to support the removable container in the frame when received in the upper opening.

64. The ovitrap of claim 62 further comprising:
a presence sensor configured to identify the presence of the container when mounted on the fixed part.

65. The ovitrap of claim 62 further comprising:
a larvae sensor configured to sense the presence of larvae and/or pupae of the water-breeding insect in the container.

66. The system of claim 62 further comprising:
one or more permanent automated ovitraps configured to automatically maintain a desired water level and dispose of collected eggs such that they do not require maintenance to be administered by the plurality of autonomous vehicles.

67. An autonomous vehicle for use in the system of any of claim 55 comprising:
an ovitrap positioning handler arranged to grip and hold an ovitrap or a container for an ovitrap such that an ovitrap or container for an ovitrap may be moved to a new location by the autonomous vehicle;
a fresh container store configured to hold one or more fresh containers for use with the ovitraps; wherein
the autonomous vehicle is configured to replace the container of an ovitrap with a container held in the fresh container store.

68. The autonomous vehicle of claim 67 further comprising:
a liquid store arranged to hold liquid for filling a container for use with an ovitrap; and
a container filling unit configured to fill a container with liquid from the liquid store; wherein the autonomous vehicle is configured to fill a container with a liquid from the liquid store and replace the container of an ovitrap with a filled container.

69. A method for the automated management of a water-breeding insect population, the method comprising:
providing one or more ovitraps over a region in which the population of a water-breeding insect is to be managed;
providing one or more ovitrap managers;
receiving information regarding the insect population at the one or more ovitrap managers;
creating a map by the one or more ovitrap managers, the map containing the received information regarding the insect population; and
adding information regarding one or more ovitraps to the map by the one or more ovitrap managers.

70. The method according to claim 69 further comprising:
dynamically adjusting the number and/or location of the one or more ovitraps in the region by the one or more ovitrap managers according to the changing insect population density.

71. The method according to claim 69 further comprising:
collecting data relating to larvae and/or pupae sensed by one or more sensors on the one or more ovitraps;
sending the data from the one or more ovitraps to the one or more ovitrap managers.

72. The method according to claim 69 further comprising:
receiving manually inputted insect population data at the ovitrap manager.

73. The method according to claim 69 wherein one or more ovitraps are ovitraps configured to be managed by an autonomous vehicle, the method comprising:
instructing one or more autonomous vehicles to perform one or more tasks to administer maintenance of the one or more ovitraps.

74. The method according to claim 69 wherein one or more ovitraps are permanent automated ovitraps and the global manager is configured to remotely instruct the one or more permanent ovitraps to place them in an active or an inactive state.

75. The method according to claim 69 further comprising:
creating an automated schedule of maintenance tasks to be administered across the one or more ovitraps by the one or more ovitrap managers.

76. The method according to claim 75 further comprising:
sending an alert to a user device if a task in the automated schedule of maintenance tasks cannot be completed.

77. The method according to claim 69 further comprising:
sending the map from an ovitrap manager to a user device;
displaying the map on a display of the user device.
